(19) United States
(12) Patent Application Publication
(10) Pub. No.: US 2024/0155667 A1
(43) Pub. Date: May 9, 2024

(54) ENHANCED MULTIPLEXING OF UPLINK CONTROL INFORMATION OF DIFFERENT PRIORITIES

(71) Applicant: Lenovo (Singapore) Pte. Ltd., New Tech Park (SG)

(72) Inventors: Hyejung Jung, Northbrook, IL (US); Vijay Nangia, Woodridge, IL (US); Hossein Bagheri, Urbana, IL (US)

(21) Appl. No.: 18/546,956

(22) PCT Filed: Feb. 17, 2022
(86) PCT No.: PCT/IB2022/051439

§ 371 Date: Aug. 17, 2023

Related U.S. Application Data
(60) Provisional application No. 63/150,472, filed on Feb. 17, 2021.

(51) Int. Cl. H04W 72/566; H04L 1/1829; H04W 72/21

(52) U.S. Cl. CPC H04W 72/566; H04L 1/1854; H04W 72/21

(57) ABSTRACT

Various aspects of the present disclosure relate to enhanced multiplexing of uplink control information of different priorities. An apparatus includes at least one memory and at least one processor that is configured to determine a first transmission of first uplink control information (“UCI”) on a first physical uplink control channel (“PUCCH”) having a first priority, determine a second transmission of second UCI on a second PUCCH, the second PUCCH overlapping the first PUCCH in time and having a second priority that is higher than the first priority, determine a set of PUCCH resources based on UCI bits of the first and second priorities from a PUCCH configuration associated with the second PUCCH, determine a third PUCCH based on a PUCCH resource of the set of PUCCH resources, and multiplex the UCI bits of the first and second priorities on the third PUCCH for transmission in the indicated slot.

### CROSS-REFERENCE TO RELATED APPLICATIONS

This application claims priority to U.S. Provisional Patent Application No. 63/150,472 entitled “ENHANCED MULTIPLEXING OF UPLINK CONTROL INFORMATION OF DIFFERENT PRIORITIES” and filed on Feb. 17, 2021, for Hyejung Jung, et al., which is incorporated herein by reference.

### FIELD

The subject matter disclosed herein relates generally to wireless communications and more particularly relates to enhanced multiplexing of uplink control information of different priorities.

### BACKGROUND

In certain wireless communication systems, a user equipment (“UE”) can be configured to generate two hybrid automatic repeat request-acknowledgement (“HARQ-ACK”) codebooks, one associated with a high priority physical uplink control channel (“PUCCH”) and the other associated with a low priority PUCCH. If the UE transmits a PUCCH or physical uplink shared channel (“PUSCH”) of a higher priority index that fully or partially overlaps with transmission of a PUCCH or PUSCH of a lower priority index, the UE cancels the transmission of the PUCCH or PUSCH of the lower priority index. If the cancelled transmission of the PUCCH or PUSCH of the lower priority index includes low priority (“LP”) HARQ-ACK information, HARQ-ACK feedback with the LP HARQ-ACK information is also cancelled. If cancellation of HARQ-ACK feedback occurs frequently, downlink throughput corresponding to low priority DL packets (e.g., enhanced mobile broadband (“eMBB”) traffic) may be significantly degraded.

### BRIEF SUMMARY

Disclosed are procedures for enhanced multiplexing of uplink control information of different priorities. Said procedures may be implemented by apparatus, systems, methods, and/or computer program products.

In one embodiment, a first apparatus includes a processor that determines a first transmission of first uplink control information (“UCI”) on a first physical uplink control channel (“PUCCH”), the first PUCCH having a first priority. In one embodiment, the processor determines a second transmission of second UCI on a second PUCCH, the second PUCCH overlapping the first PUCCH in time and having a second priority that is higher than the first priority of the first PUCCH. In one embodiment, the processor determines a set of PUCCH resources based on UCI bits of the first and second priorities from a PUCCH configuration associated with the second PUCCH, wherein the UCI bits of the first and second priorities are selected from the first and second UCI. In one embodiment, the processor determines a third PUCCH based on a PUCCH resource of the set of PUCCH resources, the PUCCH resource determined based on a downlink control information (“DCI”) format among detected one or more DCI formats indicating the second priority and a slot of the second PUCCH transmission. In one embodiment, the processor multiplexes the UCI bits of the first and second priorities on the third PUCCH for transmission in the indicated slot.

In one embodiment, a first method includes determining a first transmission of first uplink control information (“UCI”) on a first physical uplink control channel (“PUCCH”), the first PUCCH having a first priority. In one embodiment, the first method includes determining a second transmission of second UCI on a second PUCCH, the second PUCCH overlapping the first PUCCH in time and having a second priority that is higher than the first priority of the first PUCCH. In one embodiment, the first method includes determining a set of PUCCH resources based on UCI bits of the first and second priorities from a PUCCH configuration associated with the second PUCCH, wherein the UCI bits of the first and second priorities are selected from the first and second UCI. In one embodiment, the first method includes determining a third PUCCH based on a PUCCH resource of the set of PUCCH resources, the PUCCH resource determined based on a downlink control information (“DCI”) format among detected one or more DCI formats indicating the second priority and a slot of the second PUCCH transmission. In one embodiment, the first method includes multiplexing the UCI bits of the first and second priorities on the third PUCCH for transmission in the indicated slot.

In one embodiment, a second apparatus includes a processor that schedules a first transmission of first uplink control information (“UCI”) on a first physical uplink control channel (“PUCCH”) by a user equipment (“UE”), the first PUCCH having a first priority. In one embodiment, the processor schedules a second transmission of second UCI on a second PUCCH by the UE, the second PUCCH overlapping the first PUCCH in time and having a second priority that is higher than the first priority of the first PUCCH. In one embodiment, the processor selects a PUCCH resource from a set of PUCCH resources for a third PUCCH, wherein the set of PUCCH resources from a PUCCH configuration associated with the second PUCCH is based on UCI bits of the first and second priorities selected from the first and second UCI. In one embodiment, the processor indicates the PUCCH resource of the set of PUCCH resources in a downlink control information (“DCI”) format among transmitted one or more DCI formats indicating the second priority and a slot of the second PUCCH transmission. In one embodiment, the second apparatus includes a transceiver that receives the third PUCCH in the indicated slot.

In one embodiment, a second method includes scheduling a first transmission of first uplink control information (“UCI”) on a first physical uplink control channel (“PUCCH”) by a user equipment (“UE”), the first PUCCH having a first priority. In one embodiment, the second method includes scheduling a second transmission of second UCI on a second PUCCH by the UE, the second PUCCH overlapping the first PUCCH in time and having a second priority that is higher than the first priority of the first PUCCH. In one embodiment, the second method includes selecting a PUCCH resource from a set of PUCCH resources for a third PUCCH, wherein the set of PUCCH resources from a PUCCH configuration associated with the second PUCCH is based on UCI bits of the first and second priorities selected from the first and second UCI. In one embodiment, the second method includes indicating the PUCCH resource of the set of PUCCH resources in a downlink control information (“DCI”) format among transmitted one or more DCI formats indicating the second priority and a slot of the second PUCCH transmission. In one embodiment, the second method includes receiving the third PUCCH in the indicated slot.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for enhanced multiplexing of uplink control information of different priorities;

FIG. 2 is an example of multiplexing of UCI of mixed priorities for multiple overlapping PUCCHs for enhanced multiplexing of uplink control information of different priorities;

FIG. 3 is a block diagram illustrating one embodiment of a user equipment apparatus that may be used for enhanced multiplexing of uplink control information of different priorities;

FIG. 4 is a block diagram illustrating one embodiment of a network apparatus that may be used for enhanced multiplexing of uplink control information of different priorities;

FIG. 5 is a flowchart diagram illustrating one embodiment of a method for enhanced multiplexing of uplink control information of different priorities; and

FIG. 6 is a flowchart diagram illustrating one embodiment of another method for enhanced multiplexing of uplink control information of different priorities.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of' includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for enhanced multiplexing of uplink control information of different priorities. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In Rel-15 NR, a PUCCH resource for HARQ-ACK feedback of a particular priority index in response to a physical downlink control channel (“PDCCH”) (including a physical downlink shared channel (“PDCCH”) reception with a corresponding PDCCH) is determined based on a last DCI format indicating the particular priority index.

In 3GPP Rel-16 NR, a UE can be configured to generate two HARQ-ACK codebooks, one associated with a high priority PUCCH and the other associated with a low priority PUCCH. If the UE would transmit a PUCCH or PUSCH of a higher priority index that fully or partially overlaps with transmission of a PUCCH or PUSCH of a lower priority index, the UE cancels the transmission of the PUCCH or PUSCH of the lower priority index. If the cancelled transmission of the PUCCH or PUSCH of the lower priority index includes low priority (LP) HARQ-ACK information, HARQ-ACK feedback with the LP HARQ-ACK information is also cancelled. If cancellation of HARQ-ACK feedback occurs frequently, downlink throughput corresponding to low priority DL packets (e.g., eMBB traffics) may be significantly degraded.

For Rel-17 NR, multiplexing of LP HARQ-ACK information with high priority (“HP”) uplink control information (“UCI”) in PUCCH or PUSCH is being considered.

This disclosure presents methods to ensure necessary reliability for HP UCI transmission while multiplexing LP UCI (e.g., HARQ-ACK) with HP UCI in an uplink channel In the proposed method, a PUCCH resource for HARQ-ACK feedback of mixed priorities is determined based on a last DCI format of a higher priority index or a last DCI format of a lower priority index indicating a higher priority PUCCH resource, to protect HP HARQ-ACK. Further, repetition of the higher priority PUCCH resource can provide necessary reliability of HP HARQ-ACK transmission.

In one embodiment, when a UE transmits LP UCI in a first PUCCH and transmits HP UCI in a second PUCCH overlapping with the first PUCCH in time, if configured, the UE multiplexes the LP UCI with the HP UCI into a third PUCCH and further applies repetitions of the third PUCCH over multiple slots or multiple sub-slots. An initial transmission occasion of the third PUCCH is determined based on the earliest symbol from the first and second PUCCHs. The last transmission occasion of the third PUCCH is determined based on a sub-slot, where the last symbol of the second PUCCH is located.

In another embodiment, when a UE transmits LP HARQ-ACK in a first PUCCH and transmits HP UCI, including at least HP HARQ-ACK feedback in response to a PDCCH, in a second PUCCH overlapping with the first PUCCH in time, the UE determines a PUCCH resource from a set of PUCCH resources of a PUCCH configuration associated with a higher priority index, based on a PUCCH resource indicator field, if present, in a last DCI format indicating a higher priority index.

In some embodiments, when a UE transmits at least LP HARQ-ACK feedback in response to a PDCCH in a first PUCCH and transmits HP UCI including HP HARQ-ACK feedback only for one or more semi-persistent scheduling (“SPS”) PDCCH receptions without corresponding PDCCHs in a second PUCCH overlapping with the first PUCCH in time, the UE determines a PUCCH resource from a set of PUCCH resources of a PUCCH configuration associated with a higher priority index, based on a PUCCH resource indicator field, if present, in a last DCI format indicating a lower priority index.

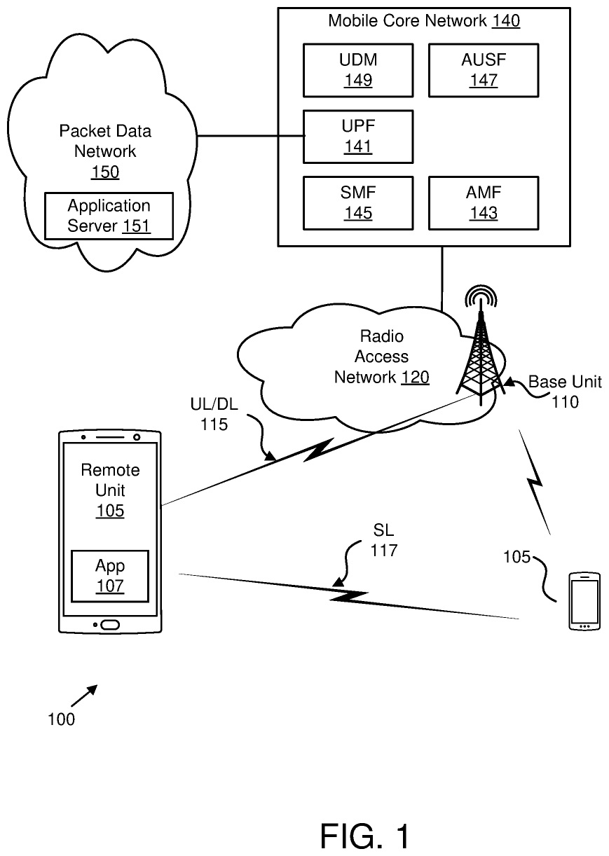

FIG. 1 depicts a wireless communication system 100 supporting enhanced multiplexing of uplink control information of different priorities, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 110 with which the remote unit 105 communicates using wireless communication links 115. Even though a specific number of remote units 105, base units 110, wireless communication links 115, RANs 120, and mobile core networks 140 are depicted in FIG. 1, one of skill in the art will recognize that any number of remote units 105, base units 110, wireless communication links 115, RANs 120, and mobile core networks 140 may be included in the wireless communication system 100.

In one implementation, the RAN 120 is compliant with the 5G system specified in the 3GPP specifications. In another implementation, the RAN 120 is compliant with the LTE system specified in the 3GPP specifications. More generally, however, the wireless communication system 100 may implement some other open or proprietary communication network, for example WiMAX, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art.

The remote units 105 may communicate directly with one or more of the base units 110 in the RAN 120 via uplink (“UL”) and downlink (“DL”) communication signals. Furthermore, the UL and DL communication signals may be carried over the wireless communication links 115. Here, the RAN 120 is an intermediate network that provides the remote units 105 with access to the mobile core network 140.

In some embodiments, the remote units 105 communicate with an application server 151 via a network connection with the mobile core network 140. For example, an application 107 (e.g., web browser, media client, telephone/VoIP application) in a remote unit 105 may trigger the remote unit 105 to establish a PDU session (or other data connection) with the mobile core network 140 via the RAN 120. The mobile core network 140 then relays traffic between the remote unit 105 and the application server 151 in the packet data network 150 using the PDU session. Note that the remote unit 105 may establish one or more PDU sessions (or other data connections) with the mobile core network 140. As such, the remote unit 105 may concurrently have at least one PDU session for communicating with the packet data network 150 and at least one PDU session for communicating with another data network (not shown).

The base units 110 may be distributed over a geographic region. In certain embodiments, a base unit 110 may also be referred to as an access terminal, an access point, a base, a base station, a Node-B, an eNB, a gNB, a Home Node-B, a relay node, a RAN node, or by any other terminology used in the art. The base units 110 are generally part of a radio access network (“RAN”), such as the RAN 120, that may include one or more controllers communicably coupled to one or more corresponding base units 110. These and other elements of radio access network are not illustrated but are well known generally by those having ordinary skill in the art. The base units 110 connect to the mobile core network 140 via the RAN 120.

The base units 110 may serve a number of remote units 105 within a serving area, for example, a cell or a cell sector, via a wireless communication link 115. The base units 110 may communicate directly with one or more of the remote units 105 via communication signals. Generally, the base units 110 transmit DL communication signals to serve the remote units 105 in the time, frequency, and/or spatial domain. Furthermore, the DL communication signals may be carried over the wireless communication links 115. The wireless communication links 115 may be any suitable carrier in licensed or unlicensed radio spectrum. The wireless communication links 115 facilitate communication between one or more of the remote units 105 and/or one or more of the base units 110. Note that the base unit 110 and the remote unit 105 may communicate over unlicensed radio spectrum.

In one embodiment, the mobile core network 140 is a 5G core (“5GC”) or the evolved packet core (“EPC”), which may be coupled to a packet data network 150, like the Internet and private data networks, among other data networks. A remote unit 105 may have a subscription or other account with the mobile core network 140. Each mobile core network 140 belongs to a single public land mobile network (“PLMN”). The present disclosure is not intended to be limited to the implementation of any particular wireless communication system architecture or protocol.

The mobile core network 140 includes several network functions (“NFs”). As depicted, the mobile core network 140 includes multiple user plane functions (“UPFs”) 141. The mobile core network 140 also includes multiple control plane functions including, but not limited to, an Access and Mobility Management Function (“AMF”) 143 that serves the RAN 120, a Session Management Function (“SMF”) 145, an Authentication Server Function (“AUSF”) 147, and a Unified Data Management function (“UDM”) 149. In certain embodiments, the mobile core network 140 may also include a Policy Control Function (“PCF”), a Network Repository Function (“NRF”) (used by the various NFs to discover and communicate with each other over APIs), or other NFs defined for the 5GC.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. A network instance may be identified by a S-NSSAI, while a set of network slices for which the remote unit 105 is authorized to use is identified by NSSAI. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

Although specific numbers and types of network functions are depicted in FIG. 1, one of skill in the art will recognize that any number and type of network functions may be included in the mobile core network 140. Moreover, where the mobile core network 140 is an EPC, the depicted network functions may be replaced with appropriate EPC entities, such as an MME, S-GW, P-GW, HSS, and the like. In certain embodiments, the mobile core network 140 may include a AAA server.

In various embodiments, the remote units 105 may communicate directly with each other (e.g., device-to-device communication) using sidelink (“SL”) communication signals 117. V2X is one example of SL communication. Here, V2X transmissions may occur on V2X resources. The remote unit 105 may be provided with different V2X communication resources for different V2X modes. Mode-1 corresponds to a NR network-scheduled V2X communication mode. Mode-2 corresponds to an LTE network-scheduled V2X communication mode.

While FIG. 1 depicts components of a 5G RAN and a 5G core network, the described embodiments apply to other types of communication networks and RATs, including IEEE 802.11 variants, GSM, GPRS, UMTS, LTE variants, CDMA 2000, Bluetooth, ZigBee, Sigfoxx, and the like. For example, in an LTE variant involving an EPC, the AMF 141 may be mapped to an MME, the SMF mapped to a control plane portion of a PGW and/or to an MME, the UPF map to an SGW and a user plane portion of the PGW, the UDM/UDR maps to an HSS, etc.

In the following descriptions, the term “gNB” is used for the base station but it is replaceable by any other radio access node, e.g., RAN node, eNB, BS, eNB, gNB, AP, NR, etc. Further the operations are described mainly in the context of 5G NR.

According to Rel-16 3GPP NR spec TS 38.213, procedures related to UCI reporting in PUCCH and UCI reporting in PUSCH are specified as follows:

A PUSCH or a PUCCH transmission, including repetitions if any, can be of priority index 0 or of priority index 1. For a configured grant PUSCH transmission, a UE determines a priority index from priority, if provided. For a PUCCH transmission with HARQ-ACK information corresponding to a SPS PDSCH reception or a SPS PDSCH release, a UE determines a priority index from harq-CodebookID, if provided. For a PUCCH transmission with scheduling request (“SR”), a UE determines the corresponding priority. For a PUSCH transmission with semi-persistent channel state information (“CSI”) report, a UE determines a priority index from a priority indicator field, if provided, in a DCI format 0_1 or DCI format 0_2 that activates the semi-persistent CSI report. If a priority index is not provided to a UE for a PUSCH or a PUCCH transmission, the priority index is 0.

If a UE is provided two PUCCH-Config
i. if the UE is provided subslotLengthForPUCCH-r16 in the first PUCCH-Config, the PUCCH resource for any SR configuration with priority index 0 or any CSI report configuration in any PUCCH-Config is within the subslotLengthForPUCCH-r16 symbols in the first PUCCH-Config;
ii. if the UE is provided subslotLengthForPUCCH-r16 in the second PUCCH-Config, the PUCCH resource for any SR configuration with priority index 1 in any PUCCH-Config is within the sub slotLengthForPUCCH-r16 symbols in the second PUCCH-Config

If in an active downlink (“DL”) bandwidth part (“BWP”), a UE monitors PDCCH either for detection of DCI format 0_1 and DCI format 1_1 or for detection of DCI format 0_2 and DCI format 1_2, a priority index can be provided by a priority indicator field. If a UE indicates a capability to monitor, in an active DL BWP, PDCCH for detection of DCI format 0_1 and DCI format 1_1 and for detection of DCI format 0_2 and DCI format 1_2, a DCI format 0_1 or a DCI format 0_2 can schedule a PUSCH transmission of any priority and a DCI format 1_1 or a DCI format 1_2 can schedule a PDSCH reception and trigger a PUCCH transmission with corresponding HARQ-ACK information of any priority.

When a UE determines overlapping for PUCCH and/or PUSCH transmissions of different priority indexes, the UE first resolves the overlapping for PUCCH and/or PUSCH transmissions of smaller priority index. Then,
i. if a transmission of a first PUCCH of larger priority index scheduled by a DCI format in a PDCCH reception would overlap in time with a transmission of a second PUSCH or a second PUCCH of smaller priority index, the UE cancels the transmission of the second PUSCH or the second PUCCH before the first symbol that would overlap with the first PUCCH transmission
ii. if a transmission of a first PUSCH of larger priority index scheduled by a DCI format in a PDCCH reception would overlap in time with a transmission of a second PUCCH of smaller priority index, the UE cancels the transmission of the second PUCCH before the first symbol that would overlap with the first PUSCH transmission

where
i. the overlapping is applicable before or after resolving overlapping among channels of larger priority index, if any
ii. the UE expects that the transmission of the first PUCCH or the first PUSCH, respectively, would not start before T_{proc,2}+d₁ after a last symbol of the corresponding PDCCH reception
iii. T_{proc,2} is the PUSCH preparation time for a corresponding UE processing capability assuming d_{2,1}=0, based on μ and N₂ as subsequently defined herein, and d₁ is determined by a reported UE capability.

If a UE is scheduled by a DCI format in a first PDCCH reception to transmit a first PUCCH or a first PUSCH of larger priority index that overlaps with a second PUCCH or a second PUSCH transmission of smaller priority index that, if any, is scheduled by a DCI format in a second PDCCH
i. T_{proc,2} is based on a value of μ corresponding to the smallest subcarrier spacing (“SCS”) configuration of the first PDCCH, the second PDCCHs, the first PUCCH or the first PUSCH, and the second PUCCHs or the second PUSCHs
   1. if the overlapping group includes the first PUCCH
      a. if processingType2Enabled of PDSCH-ServingCellConfig is set to enable for the serving cell where the UE receives the first PDCCH and for all serving cells where the UE receives the PDSCHs corresponding to the second PUCCHs, and if processingType2Enabled of PUSCH-ServingCellConfig is set to enable for the serving cells with the second PUSCHs, N₂ is 5 for μ=0, 5.5 for μ=1 and 11 for μ=2
      b. else, N₂ is 10 for μ=0, 12 for μ=1, 23 for μ=2, and 36 for μ=3;
   2. if the overlapping group includes the first PUSCH
      a. if processingType2Enabled of PUSCH-ServingCellConfig is set to enable for the serving cells with the first PUSCH and the second PUSCHs and if processingType2Enabled of PDSCH-ServingCellConfig is set to enable for all serving cells where the UE receives the PDSCHs corresponding to the second PUCCHs, N₂ is 5 for μ=0, 5.5 for μ=1 and 11 for μ=2
      b. else, N₂ is 10 for μ=0, 12 for μ=1, 23 for μ=2, and 36 for μ=3;

If a UE would transmit the following channels that would overlap in time:
i. a first PUCCH of larger priority index with SR and a second PUCCH or PUSCH of smaller priority index, or
ii. a configured grant PUSCH of larger priority index and a PUCCH of smaller priority index, or
iii. a first PUCCH of larger priority index with HARQ-ACK information only in response to a PDSCH reception without a corresponding PDCCH and a second PUCCH of smaller priority index with SR and/or CSI, or a configured grant PUSCH with smaller priority index, or a PUSCH of smaller priority index with SP-CSI report(s) without a corresponding PDCCH, or
iv. a PUSCH of larger priority index with SP-CSI reports(s) without a corresponding PDCCH and a PUCCH of smaller priority index with SR, or CSI, or HARQ-ACK information only in response to a PDSCH reception without a corresponding PDCCH, or
v. a configured grant PUSCH of larger priority index and a configured PUSCH of lower priority index on a same serving cell

the UE is expected to cancel the PUCCH/PUSCH transmissions of smaller priority index before the first symbol overlapping with the PUCCH/PUSCH transmission of larger priority index.

A UE does not expect to be scheduled to transmit a PUCCH or a PUSCH with smaller priority index that would overlap in time with a PUCCH of larger priority index with HARQ-ACK information only in response to a PDSCH reception without a corresponding PDCCH. A UE does not expect to be scheduled to transmit a PUCCH of smaller priority index that would overlap in time with a PUSCH of larger priority index with SP-CSI report(s) without a corresponding PDCCH.

Herein, a UE multiplexes UCIs with same priority index in a PUCCH or a PUSCH. A PUCCH or a PUSCH is assumed to have a same priority index as a priority index of UCIs a UE multiplexes in the PUCCH or the PUSCH.

Herein, if a UE is provided subslotLengthForPUCCH-r16, a slot for an associated PUCCH transmission includes a number of symbols indicated by subslotLengthForPUCCH-r16.

If a UE would transmit on a serving cell a PUSCH without UL-SCH that overlaps with a PUCCH transmission on a serving cell that includes positive SR information, the UE does not transmit the PUSCH.

If a UE would transmit CSI reports on overlapping physical channels, the UE applies the priority rules for the multiplexing of CSI reports.

If a UE has overlapping resources for PUCCH transmissions in a slot and at least one of the PUCCH transmissions is with repetitions over multiple slots, the UE first follows the procedures for resolving the overlapping among the resources for the PUCCH transmissions.

If a UE
i. would multiplex UCI in a PUCCH transmission that overlaps with a PUSCH transmission, and
ii. the PUSCH and PUCCH transmissions fulfill the conditions for UCI multiplexing,

the UE
i. multiplexes only HARQ-ACK information, if any, from the UCI in the PUSCH transmission and does not transmit the PUCCH if the UE multiplexes aperiodic or semi-persistent CSI reports in the PUSCH;
ii. multiplexes only HARQ-ACK information and CSI reports, if any, from the UCI in the PUSCH transmission and does not transmit the PUCCH if the UE does not multiplex aperiodic or semi-persistent CSI reports in the PUSCH.

A UE does not expect to multiplex in a PUSCH transmission in one slot with SCS configuration μ₁ UCI of same type that the UE would transmit in PUCCHs in different slots with SCS configuration μ₂ if μ₁<μ₂.

A UE does not expect to multiplex in a PUSCH transmission or in a PUCCH transmission HARQ-ACK information that the UE would transmit in different PUCCHs.

A UE does not expect a PUCCH resource that results from multiplexing overlapped PUCCH resources, if applicable, to overlap with more than one PUSCHs if each of the more than one PUSCHs includes aperiodic CSI reports.

A UE does not expect to detect a DCI format scheduling a PDSCH reception or a SPS PDSCH release, or a DCI format including a One-shot HARQ-ACK request field with value 1 and indicating a resource for a PUCCH transmission with corresponding HARQ-ACK information in a slot if the UE previously detects a DCI format scheduling a PUSCH transmission in the slot and if the UE multiplexes HARQ-ACK information in the PUSCH transmission.

If a UE multiplexes aperiodic CSI in a PUSCH and the UE would multiplex UCI that includes HARQ-ACK information in a PUCCH that overlaps with the PUSCH and the timing conditions for overlapping PUCCHs and PUSCHs are fulfilled, the UE multiplexes only the HARQ-ACK information in the PUSCH and does not transmit the PUCCH.

If a UE transmits multiple PUSCHs in a slot on respective serving cells that include first PUSCHs that are scheduled by DCI formats and second PUSCHs configured by respective ConfiguredGrantConfig or semiPersistentOnPUSCH, and the UE would multiplex UCI in one of the multiple PUSCHs, and the multiple PUSCHs fulfil the conditions for UCI multiplexing, the UE multiplexes the UCI in a PUSCH from the first PUSCHs.

If a UE transmits multiple PUSCHs in a slot on respective serving cells and the UE would multiplex UCI in one of the multiple PUSCHs and the UE does not multiplex aperiodic CSI in any of the multiple PUSCHs, the UE multiplexes the UCI in a PUSCH of the serving cell with the smallest ServCellIndex subject to the conditions for UCI multiplexing being fulfilled. If the UE transmits more than one PUSCHs in the slot on the serving cell with the smallest ServCellIndex that fulfil the conditions for UCI multiplexing, the UE multiplexes the UCI in the earliest PUSCH that the UE transmits in the slot.

If a UE transmits a PUSCH over multiple slots and the UE would transmit a PUCCH with HARQ-ACK and/or CSI information over a single slot that overlaps with the PUSCH transmission in one or more slots of the multiple slots, and the PUSCH transmission in the one or more slots fulfills the conditions for multiplexing the HARQ-ACK and/or CSI information, the UE multiplexes the HARQ-ACK and/or CSI information in the PUSCH transmission in the one or more slots. The UE does not multiplex HARQ-ACK and/or CSI information in the PUSCH transmission in a slot from the multiple slots if the UE would not transmit a single-slot PUCCH with HARQ-ACK and/or CSI information in the slot in case the PUSCH transmission was absent.

If a UE transmits a PUSCH with repetition Type B and the UE would transmit a PUCCH with HARQ-ACK and/or CSI information over a single slot that overlaps with the PUSCH transmission in one or more slots, the UE expects all actual repetitions of the PUSCH transmission that would overlap with the PUCCH transmission to fulfill the conditions for multiplexing the HARQ-ACK and/or CSI information, and the UE multiplexes the HARQ-ACK and/or CSI information in the earliest actual PUSCH repetition of the PUSCH transmission that would overlap with the PUCCH transmission and includes more than one symbol. The UE does not expect that all actual repetitions that would overlap with the PUCCH transmission do not include more than one symbol.

If the PUSCH transmission over the multiple slots is scheduled by a DCI format that includes a downlink assignment index (“DAP”) field, the value of the DAI field is applicable for multiplexing HARQ-ACK information in the PUSCH transmission in any slot from the multiple slots where the UE multiplexes HARQ-ACK information.

If a UE is provided pdsch-HARQ-ACK-Codebook-List, the UE can be indicated by pdsch-HARQ-ACK-Codebook-List to generate one or two HARQ-ACK codebooks. If the UE is indicated to generate one HARQ-ACK codebook, the HARQ-ACK codebook is associated with a PUCCH of priority index 0. If a UE is provided pdsch-HARQ-ACK-Codebook-List, the UE multiplexes in a same HARQ-ACK codebook only HARQ-ACK information associated with a same priority index. If the UE is indicated to generate two HARQ-ACK codebooks
i. a first HARQ-ACK codebook is associated with a PUCCH of priority index 0 and a second HARQ-ACK codebook is associated with a PUCCH of priority index 1;
ii. the UE is provided first and second for each of {PUCCH-Config, UCI-OnPUSCH, PDSCH-codeBlockGroupTransmission} by {PUCCHConfigurationList, UCI-OnPUSCH-List, PDSCH-CodeBlockGroupTransmission-List}, respectively, for use with the first and second HARQ-ACK codebooks, respectively.

If a UE receives a PDSCH without receiving a corresponding PDCCH, or if the UE receives a PDCCH indicating a SPS PDSCH release, the UE generates one corresponding HARQ-ACK information bit. If the UE generates two HARQ-ACK codebooks, the UE is indicated by harq-CodebookID, per SPS PDSCH configuration, a HARQ-ACK codebook index for multiplexing the corresponding HARQ-ACK information bit.

If a UE is provided pdsch-HARQ-ACK-OneShotFeedb ack-r16 and the UE detects a DCI format in any PDCCH monitoring occasion that includes a One-shot HARQ-ACK request field with value 1
i. the UE includes the HARQ-ACK information in a Type-3 HARQ-ACK codebook
ii. the UE does not expect that the PDSCH-to-HARQ_feedback timing indicator field of the DCI format provides an inapplicable value from dl-DataToUL-ACK

Herein, reference is to one HARQ-ACK codebook and to DCI formats that schedule PDSCH reception, or indicate SPS PDSCH release, or indicate SCell dormancy without scheduling a PDSCH reception and are associated with the HARQ-ACK codebook.

If a UE is configured to receive SPS PDSCHs in a slot for SPS configurations that are indicated to be released by a DCI format, and if the UE receives the PDCCH providing the DCI format in the slot where the end of a last symbol of the PDCCH reception is not after the end of a last symbol of any of the SPS PDSCH receptions, and if HARQ-ACK information for the SPS PDSCH release and the SPS PDSCH receptions would be multiplexed in a same PUCCH, the UE does not expect to receive the SPS PDSCHs, does not generate HARQ-ACK information for the SPS PDSCH receptions, and generates a HARQ-ACK information bit for the SPS PDSCH release.

If a UE detects a DCI format 1_1 indicating
i. SCell dormancy without scheduling a PDSCH reception, and
ii. is provided pdsch-HARQ-ACK-Codebook=dynamic or enhancedDynamic-r16

the UE generates a HARQ-ACK information bit for a DCI format 1_1 indicating SCell dormancy and the HARQ-ACK information bit value is ACK.

If a UE is not provided PDSCH-CodeBlockGroupTransmission, the UE generates one HARQ-ACK information bit per transport block.

For a HARQ-ACK information bit, a UE generates a positive acknowledgement (“ACK”) if the UE detects a DCI format that provides a SPS PDSCH release or correctly decodes a transport block and generates a negative acknowledgement (“NACK”) if the UE does not correctly decode the transport block. A HARQ-ACK information bit value of 0 represents a NACK while a HARQ-ACK information bit value of 1 represents an ACK.

In the following, the cyclic redundancy check (“CRC”) for a DCI format is scrambled with a cell-radio network temporary identifier (“C-RNTI”), a modulation and coding scheme (“MCS”)-C-RNTI, or a configured scheduling (“CS”)-RNTI.

If a UE is not provided pdsch-HARQ-ACK-Codebook, the UE generates at most one HARQ-ACK information bit.

If the UE provides HARQ-ACK information in a PUCCH transmission in response to detecting a DCI format scheduling a PDSCH reception or a SPS PDSCH release, the UE determines a PUCCH resource with index r_{PUCCH}, 0≤r_{PUCCH}≤15, as

$${r}_{PUCCH} = ⌊ \frac{2 \cdot {n}_{CCE , 0}}{{N}_{CCE}} ⌋ + 2 \cdot {Δ}_{PRI} ,$$

where N_{CCE} is a number of control channel elements (“CCEs”) in a control resource set (“CORESET”) of a PDCCH reception with the DCI format n_{CCE,0} is the index of a first CCE for the PDCCH reception, and Δ_{PRI} is a value of the PUCCH resource indicator field in the DCI format.

If a UE has dedicated PUCCH resource configuration, the UE is provided by higher layers with one or more PUCCH resources.

A PUCCH resource includes the following parameters:
i. a PUCCH resource index provided by pucch-ResourceId
ii. an index of the first PRB prior to frequency hopping or for no frequency hopping by startingPRB, if a UE is not provided uselnterlacePUCCH-PUSCH in BWP-UplinkDedicated
iii. an index of the first PRB after frequency hopping by secondHopPRB, if a UE is not provided useInterlacePUCCH-PUSCH in BWP-UplinkDedicated
iv. an indication for intra-slot frequency hopping by intraSlotFrequencyHopping, if a UE is not provided useInterlacePUCCH-PUSCH in BWP-UplinkDedicated
v. an index of a first interlace by interlace0, if a UE is provided useInterlacePUCCH-PUSCH in BWP-UplinkDedicated
vi. if provided, an index of a second interlace by interlace1, if a UE is provided uselnterlacePUCCH-P USCH in BWP-UplinkDedicated
vii. an index of an RB set by rb-Setlndex, if a UE is provided useInterlacePUCCH-PUSCH in BWP-UplinkDedicated
viii. a configuration for a PUCCH format provided by format

The UE expects that useInterlacePUCCH-PUSCH in BWP-UplinkCommon and useInterlacePUCCH-PUSCH in BWP-UplinkDedicated are provided either in all UL BWPs or in none of the UL BWPs for a serving cell.

If a UE is provided useInterlacePUCCH-PUSCH in BWP-UplinkDedicated, the UE determines available resource blocks (“RBs”) for PUCCH transmissions within the active UL BWP as the intersection of RBs corresponding to an interlace index provided by interlace0 and, if provided, interlace1, and RBs of an RB set provided by rb-Setlndex. The intersection results in M_{interlace,0}^{PUCCH} RBs in the first interlace and the UE expects that M_{interlace,0}^{PUCCH} is either 10 or 11. If interlace1 is provided, the intersection results in M_{interlace,1}^{PUCCH} RBs in the second interlace and the UE expects that M_{interlace,1}^{PUCCH} is either 10 or 11.

If a UE is provided subslotLengthForPUCCH-r16 in a PUCCH-Config, the first symbol of a PUCCH resource in PUCCH-Config for multiplexing HARQ-ACK in a PUCCH transmission is relative to the first symbol of the subslotLengthForPUCCH-r16 symbols. For the remaining cases, the first symbol of a PUCCH resource is relative to the first symbol of a slot with N_{sym}^{slot} symbols.

A UE can be configured up to four sets of PUCCH resources. A PUCCH resource set is provided by PUCCH-ResourceSet and is associated with a PUCCH resource set index provided by pucch-ResourceSetId, with a set of PUCCH resource indexes provided by resourceList that provides a set of pucch-ResourceId used in the PUCCH resource set, and with a maximum number of UCI information bits the UE can transmit using a PUCCH resource in the PUCCH resource set provided by maxPayloadSize. For the first PUCCH resource set, the maximum number of UCI information bits is 2. A maximum number of PUCCH resource indexes for a set of PUCCH resources is provided by maxNrofPUCCH-ResourcesPerSet. The maximum number of PUCCH resources in the first PUCCH resource set is 32 and the maximum number of PUCCH resources in the other PUCCH resource sets is 8.

If the UE transmits O_{UCI} UCI information bits, that include HARQ-ACK information bits, the UE determines a PUCCH resource set to be
i. a first set of PUCCH resources with pucch-ResourceSetId=0 if O_{UCI}≤2 including 1 or 2 HARQ-ACK information bits and a positive or negative SR on one SR transmission occasion if transmission of HARQ-ACK information and SR occurs simultaneously, or
ii. a second set of PUCCH resources with pucch-ResourceSetId=1, if provided by higher layers, if 2<O_{UCI}≤N₂ is equal to maxPayloadSize if maxPayloadSize is provided for the PUCCH resource set with pucch-ResourceSetId=1; otherwise N₂ is equal to 1706, or
iii. a third set of PUCCH resources with pucch-ResourceSetId=2, if provided by higher layers, if N₂<O_{UCI}≤N₃ where N₃ is equal to maxPayloadSize if maxPayloadSize is provided for the PUCCH resource set with pucch-ResourceSetId=2; otherwise N₃ is equal to 1706, or
iv. a fourth set of PUCCH resources with pucch-ResourceSetId=3, if provided by higher layers, if N₃<O_{UCI}≤1706.

A UE does not expect to transmit more than one PUCCH with HARQ-ACK information in a slot.

For DCI format 1_0, the PDSCH-to-HARQ_feedback timing indicator field values map to {1, 2, 3, 4, 5, 6, 7, 8}. For a DCI format, other than DCI format 1_0, scheduling a PDSCH reception or a SPS PDSCH release, the PDSCH-to-HARQ_feedback timing indicator field values, if present, map to values for a set of number of slots provided by dl-DataToUL-ACK, or dl-DataToUL-ACKForDCIFormat1_2 for DCI format 1_2.

For a SPS PDSCH reception ending in slot n, the UE transmits the PUCCH in slot n+k where k is provided by the PDSCH-to-HARQ_feedback timing indicator field, if present, in a DCI format activating the SPS PDSCH reception.

If the UE detects a DCI format that does not include a PDSCH-to-HARQ_feedback timing indicator field and schedules a PDSCH reception or activates a SPS PDSCH reception ending in slot n, the UE provides corresponding HARQ-ACK information in a PUCCH transmission within slot n+k where k is provided by dl-DataToUL-ACK, or by dl-DataToUL-ACKForDCIFormat1_2 for DCI format 1_2.

With reference to slots for PUCCH transmissions, if the UE detects a DCI format scheduling a PDSCH reception ending in slot n or if the UE detects a DCI format indicating a SPS PDSCH release through a PDCCH reception ending in slot n, or if the UE detects a DCI format that requests Type-3 HARQ-ACK codebook report and does not schedule a PDSCH reception through a PDCCH reception ending in slot n, the UE provides corresponding HARQ-ACK information in a PUCCH transmission within slot n+k, where k is a number of slots and is indicated by the PDSCH-to-HARQ_feedback timing indicator field in the DCI format, if present, or provided by dl-DataToUL-ACK, or by dl-DataToUL-ACKForDCIFormat1_2 for DCI format 1_2. k=0 corresponds to the last slot of the PUCCH transmission that overlaps with the PDSCH reception or with the PDCCH reception in case of SPS PDSCH release or in case of the DCI format that requests Type-3 HARQ-ACK codebook report and does not schedule a PDSCH reception.

A PUCCH transmission with HARQ-ACK information is subject to the limitations for UE transmissions.

For a PUCCH transmission with HARQ-ACK information, a UE determines a

PUCCH resource after determining a set of PUCCH resources for O_{UCI} HARQ-ACK information bits. The PUCCH resource determination is based on a PUCCH resource indicator field, if present, in a last DCI format, among the DCI formats that have a value of a PDSCH-to-HARQ_feedback timing indicator field, if present, or a value of dl-DataToUL-ACK, or a value of dl-DataToUL-ACKForDCIFormat 1_2 for DCI format 1_2, indicating a same slot for the PUCCH transmission, that the UE detects and for which the UE transmits corresponding HARQ-ACK information in the PUCCH where, for PUCCH resource determination, detected DCI formats are first indexed in an ascending order across serving cells indexes for a same PDCCH monitoring occasion and are then indexed in an ascending order across PDCCH monitoring occasion indexes. For indexing DCI formats within a serving cell for a same PDCCH monitoring occasion, if the UE is not provided

CORESETPoolIndex or is provided CORESETPoolIndex with value 0 for one or more first CORESETs and is provided CORESETPoolIndex with value 1 for one or more second CORESETs on an active DL BWP of a serving cell, and with ackNackFeedbackMode-r16=joint for the active UL BWP, detected DCI formats from PDCCH receptions in the first CORESETs are indexed prior to detected DCI formats from PDCCH receptions in the second CORESETs.

The PUCCH resource indicator field values map to values of a set of PUCCH resource indexes for a PUCCH resource indicator field of 3 bits, provided by resourceList for PUCCH resources from a set of PUCCH resources provided by PUCCH-ResourceSet with a maximum of eight PUCCH resources. If the PUCCH resource indicator field includes 1 bit or 2 bits, the values map to the first two values or the first four values, respectively. If the last DCI format does not include a PUCCH resource indicator field, the first value is used.

For the first set of PUCCH resources and when the size R_{PUCCH} of resourceList is larger than eight, when a UE provides HARQ-ACK information in a PUCCH transmission in response to detecting a last DCI format in a PDCCH reception, among DCI formats with a value of the PDSCH-to-HARQ_feedback timing indicator field, if present, or a value of dl-DataToUL-ACK, or a value of dl-DataToUL-ACKForDCIFormat1_2 for DCI format 1_2, indicating a same slot for the PUCCH transmission, the UE determines a PUCCH resource with index r_{PUCCH}, 0≤r_{PUCCH}≤R_{PUCCH}−1, as

$${r}_{PUCCH} = \{ \begin{matrix}⌊ \frac{{n}_{CCE , p} \cdot ⌈ {R}_{PUCCH} / 8 ⌉}{{N}_{CCE , p}} ⌋ + {Δ}_{PRI} \cdot ⌈ \frac{{R}_{PUCCH}}{8} ⌉ & if {Δ}_{PRI} < {R}_{PUCCH} mod 8 \\ \begin{matrix}⌊ \frac{{n}_{CCE , p} \cdot ⌊ {R}_{PUCCH} / 8 ⌋}{{N}_{CCE , p}} ⌋ + {Δ}_{PRI} \cdot ⌊ \frac{{R}_{PUCCH}}{8} ⌋ + \\ {R}_{PUCCH} mod 8\end{matrix} & if {Δ}_{PRI} \geq {R}_{PUCCH} mod 8\end{matrix} \}$$

where N_{CCE,p} is a number of CCEs in CORESET p of the PDCCH reception for the DCI format, n_{CCE,p} is the index of a first CCE for the PDCCH reception, and Δ_{PRI} is a value of the PUCCH resource indicator field in the DCI format. If the DCI format does not include a PUCCH resource indicator field, Δ_{PRI}=0.

If a UE detects a first DCI format indicating a first resource for a PUCCH transmission with corresponding HARQ-ACK information in a slot and also detects at a later time a second DCI format indicating a second resource for a PUCCH transmission with corresponding HARQ-ACK information in the slot, the UE does not expect to multiplex HARQ-ACK information corresponding to the second DCI format in a PUCCH resource in the slot if the PDCCH reception that includes the second DCI format is not earlier than N₃·(2048+144)·κ·2^{-μ}·T_{c} from the beginning of a first symbol of the first resource for PUCCH transmission in the slot and μ corresponds to the smallest SCS configuration among the SCS configurations of the PDCCHs providing the DCI formats and the SCS configuration of the PUCCH. If processingType2Enabled of PDSCH-ServingCellConfig is set to enable for the serving cell with the second DCI format and for all serving cells with corresponding HARQ-ACK information multiplexed in the PUCCH transmission in the slot, N₃=3 for μ=0, N₃=4.5 for μ=1, N₃=9 for μ=2; otherwise, N₃=8 for μ=0, N₃=10 for μ=1, N₃=17 for μ=2, N₃=20 for μ'3.

If a UE is not provided SPS-PUCCH-AN-List and transmits HARQ-ACK information corresponding only to a PDSCH reception without a corresponding PDCCH, a PUCCH resource for corresponding PUCCH transmission with HARQ-ACK information is provided by nlPUCCH-AN.

If a UE transmits a PUCCH with HARQ-ACK information using PUCCH format 0, the UE determines values m₀ and m_{CS} for computing a value of cyclic shift α where m₀ is provided by initialCyclicShift of PUCCH-format0 or, if initialCyclicShift is not provided, by the initial cyclic shift index and m_{CS} is determined from the value of one HARQ-ACK information bit or from the values of two HARQ-ACK information bits as in Table 1 and Table 2, respectively.

TABLE 1
Mapping of values for one HARQ-ACK information bit to
sequences for PUCCH format 0

| HARQ-ACK Value | 0 | 1 |
|---|---|---|
| Sequence cyclic shift | mcs = 0 | mcs = 6 |

TABLE 2
Mapping of values for two HARQ-ACK information
bits to sequences for PUCCH format 0

| HARQ-ACK Value | {0, 0} | {0, 1} | {1, 1} | {1, 0} |
|---|---|---|---|---|
| Sequence cyclic shift | mcs = 0 | mcs = 3 | mcs = 6 | mcs = 9 |

If a UE transmits a PUCCH with HARQ-ACK information using PUCCH format 1, the UE is provided a value for m₀ by initialCyclicShift of PUCCH-format1 or, if initialCyclicShift is not provided, by the initial cyclic shift index.

If a UE transmits a PUCCH with O_{ACK} HARQ-ACK information bits and O_{CRC} bits using PUCCH format 2 or PUCCH format 3 in a PUCCH resource that includes M_{RB}^{PUCCH} PRBs, the UE determines a number of PRBs M_{RB,min}^{PUCCH} for the PUCCH transmission to be the minimum number of PRBs, that is smaller than or equal to a number of PRBs M_{RB}^{PUCCH} provided respectively by nrofPRBs of PUCCH-format2 or nrofPRBs of PUCCH-format3 and start from the first PRB from the number of PRBs, that results to (O_{ACK}+O_{CRC})≤M_{RB,min}^{PUCCH}·N_{sc,ctrl}^{RB}·N_{symb-UCI}^{PUCCH}·Qₘ·and, if M_{RB}^{PUCCH}>1, (O_{ACK}+O_{CRC})>(M_{RB,min}^{PUCCH}−1)·N_{sc,ctrl}^{RB}·N_{symb-UCI}^{PUCCH}·Qₘ·r, where N_{sc,ctrl}^{RB}, N_{symb-UCI}^{PUCCH}, Qₘ, and r are defined in the standards. For PUCCH format 3, if M_{RB,min}^{PUCCH} is not equal 2^{α}^{₂}·3^{α}^{₃}·5^{α}^{₅}, M_{RB,min}^{PUCCH} is increased to the nearest allowed value of nrofPRBs for PUCCH-format3. If (O_{ACK}+O_{CRC})>(M_{RB}^{PUCCH}−1)·N_{sc,ctrl}^{RB}·N_{symb-UCI}^{PUCCH}·Qₘ·r, the UE transmits the PUCCH over M_{RB}^{PUCCH} PRBs.

If a UE is provided a first interlace of M_{Interlace,0}^{PUCCH} PRBs by interlace0 in InterlaceAllocation-r16 and transmits a PUCCH with O_{ACK} HARQ-ACK information bits and O_{CRC} bits using PUCCH format 2 or PUCCH format 3, the UE transmits the PUCCH over the first interlace if (O_{ACK}+O_{CRC})≤M_{Interlace,0}^{PUCCH}·N_{sc,ctrl}^{RB}·N_{symb-UCI}^{PUCCH}·Qₘ·r; otherwise, if the UE is provided a second interlace by interlace1 in PUCCH-format2 or PUCCH-format3, the UE transmits the PUCCH over the first and second interlaces.

A UE can be configured by SchedulingRequestResourceConfig a set of configurations for SR in a PUCCH transmission using either PUCCH format 0 or PUCCH format 1. A UE can be configured by schedulingRequestID-BFR-SCell-r16 a configuration for LRR in a PUCCH transmission using either PUCCH format 0 or PUCCH format 1. The UE can be provided, by phy-PriorityIndex-r16 in SchedulingRequestResourceConfig, a priority index 0 or a priority index 1 for the SR. If the UE is not provided a priority index for SR, the priority index is 0.

The UE is configured a PUCCH resource by SchedulingRequestResourceId, or by schedulingRequestID-BFR-SCell-r16, providing a PUCCH format 0 resource or a PUCCH format 1 resource. The UE is also configured a periodicity SR_{PERIODICITY} in symbols or slots and an offset SR_{OFFSET} in slots by periodicityAndOffset for a PUCCH transmission conveying SR. If SR_{PERIODICITY} is larger than one slot, the UE determines a SR transmission occasion in a PUCCH to be in a slot with number n_{s,f}^{μ} in a frame with number n_{f} if (n_{f}·Nₛₗₒₜ^{frame,μ}+n_{s,f}^{μ}−SR_{OFFSET})mod SR_{PERIODICITY}=0.

If SR_{PERIODICITY} is one slot, the UE expects that SR_{OFFSET}=0 and every slot is a SR transmission occasion in a PUCCH.

If SR_{PERIODICITY} is smaller than one slot, the UE determines a SR transmission occasion in a PUCCH to start in a symbol with index l if (l−l₀ mod SR_{PERIODICITY})mod SR_{PERIODICITY}=0 where l₀ is the value of startingSymbolIndex.

If the UE determines that, for a SR transmission occasion in a PUCCH, the number of symbols available for the PUCCH transmission in a slot is smaller than the value provided by nrofSymbols, the UE does not transmit the PUCCH in the slot.

SR transmission occasions in a PUCCH are subject to the limitations for UE transmissions.

The UE transmits a PUCCH in the PUCCH resource for the corresponding SR configuration only when the UE transmits a positive SR. For a positive SR transmission using PUCCH format 0, the UE transmits the PUCCH by obtaining m₀ and by setting m_{cs}=0. For a positive SR transmission using PUCCH format 1, the UE transmits the PUCCH by setting b(0)=0.

In the following, a UE is configured to transmit K PUCCHs for respective K SRs in a slot, as determined by a set of schedulingRequestResourceId and a schedulingRequestResourceId associated with schedulingRequestID-BFR-SCell-r16, with SR transmission occasions that would overlap with a transmission of a PUCCH with HARQ-ACK information from the UE in the slot or with a transmission of a PUCCH with CSI report(s) from the UE in the slot.

If a UE would transmit a PUCCH with positive SR and at most two HARQ-ACK information bits in a resource using PUCCH format 0, the UE transmits the PUCCH in the resource using PUCCH format 0 in PRB(s) for HARQ-ACK information. The UE determines a value of m₀ and m_{cs} for computing a value of cyclic shift α where m₀ is provided by initialcyclicshift of PUCCH-format0, and m_{cs} is determined from the value of one HARQ-ACK information bit or from the values of two HARQ-ACK information bits as in Table 3 and Table 4, respectively.

If the UE would transmit negative SR and a PUCCH with at most two HARQ-ACK information bits in a resource using PUCCH format 0, the UE transmits the PUCCH in the resource using PUCCH format 0 for HARQ-ACK information.

TABLE 3
Mapping of values for one HARQ-ACK information bit
and positive SR to sequences for PUCCH format 0

| HARQ-ACK Value | 0 | 1 |
|---|---|---|
| Sequence cyclic shift | mcs = 3 | mcs = 9 |

TABLE 4
Mapping of values for two HARQ-ACK information bits
and positive SR to sequences for PUCCH format 0

| HARQ-ACK Value | {0, 0} | {0, 1} | {1, 1} | {1, 0} |
|---|---|---|---|---|
| Sequence cyclic shift | mcs =1 | mcs = 4 | mcs = 7 | mcs =10 |

If a UE would transmit SR in a resource using PUCCH format 0 and HARQ-ACK information bits in a resource using PUCCH format 1 in a slot, the UE transmits only a PUCCH with the HARQ-ACK information bits in the resource using PUCCH format 1.

If the UE would transmit positive SR in a first resource using PUCCH format 1 and at most two HARQ-ACK information bits in a second resource using PUCCH format 1 in a slot, the UE transmits a PUCCH with HARQ-ACK information bits in the first resource using PUCCH format 1. If a UE would not transmit a positive SR in a resource using PUCCH format 1 and would transmit at most two HARQ-ACK information bits in a resource using PUCCH format 1 in a slot, the UE transmits a PUCCH in the resource using PUCCH format 1 for HARQ-ACK information.

Several embodiments are described below for the case that a UE has resources for

PUCCH transmissions or for PUCCH and PUSCH transmissions that overlap in time. According to a possible embodiment, one or more elements or features from one or more of the described embodiments may be combined.

When a UE determines overlapping for PUCCH and/or PUSCH transmissions of different priority indexes, the UE first resolves the overlapping for PUCCH and/or PUSCH transmissions with the same priority index for each priority index.

In one embodiment, when a UE would transmit low priority UCI in a first PUCCH and would transmit high priority UCI in a second PUCCH overlapping with the first PUCCH in time, if configured, the UE multiplexes the LP UCI with the HP UCI into a third PUCCH and further applies repetitions of the third PUCCH over multiple slots or multiple sub-slots. The first PUCCH is configured under (or according to) a first PUCCH configuration with a first sub-slot length (or a slot length or a number of symbols), and the second PUCCH is configured under a second PUCCH configuration with a second sub-slot length (or the slot length or a number of symbols). The first PUCCH configuration is associated with a lower priority index, and the second PUCCH configuration is associated with a higher priority index.

In one example, the third PUCCH is configured under the first PUCCH

configuration with the lower priority index. In another example, the third PUCCH is configured under the second PUCCH configuration with the higher priority index. In an example, a resource of the third PUCCH is same as a resource of the first PUCCH or same as a resource of the second PUCCH. In another example, a resource of the third PUCCH is different than a resource of the first PUCCH and different than a resource of the second PUCCH. In an example, the third PUCCH is configured according to the second PUCCH configuration, however, with one or more of the PUCCH configuration parameters being different than the second PUCCH configuration parameters applied to the second PUCCH, for instance,
a. PUCCH-PowerControl or PUCCH-SpatialRelationInfo parameter may contain offsets to be applied (e.g., to Po value) when the HP PUCCH of the second PUCCH configuration overlaps with an LP PUCCH of the first PUCCH configuration or
b. an offset is applied to the radio resource control (“RRC”) configured number of PUCCH repetitions in case of overlap with an LP PUCCH or
c. an offset is applied to the RRC configured nrofPRBs, and/or nrofSymbols in case of overlap with an LP PUCCH

The offset values in this example can be dependent of the first PUCCH configuration, such as subslotLengthForPUCCH.

In one example, the first sub-slot length is same as the second sub-slot length. In another example, the first sub-slot length for a PUCCH configuration of a lower priority index is longer than the second sub-slot length for a PUCCH configuration of a higher priority index.

In one implementation, if intra-UE PUCCH/PUSCH multiplexing timeline requirements are satisfied, the UE may determine an initial transmission occasion (or repetition) of the third PUCCH based on the earliest symbol from the first and second PUCCHs (or the earliest symbol from initial transmission occasions (or repetitions) of the first and second PUCCHs). If intra-UE PUCCH/PUSCH multiplexing timeline requirements are not satisfied, the UE may determine an initial transmission occasion (or repetition) of the third PUCCH based on the earliest sub-slot of the second sub-slot length that satisfies the multiplexing timeline requirements.

In one implementation, the UE may determine the last transmission occasion (or

repetition) of the third PUCCH based on a sub-slot of the second sub-slot length, where the last symbol of the second PUCCH (or the last symbol of the last transmission occasion (or repetition) of the second PUCCH) is located. That is, transmission of the third PUCCH is completed by (or no later than) an end of the sub-slot originally scheduled for HP UCI.

In one implementation, the UE may determine the last transmission occasion (or

repetition) of the third PUCCH based on a sub-slot of the second sub-slot length, and such that at least ‘x’ PUCCH repetitions are performed. In an example, ‘x’ is determined to be the number of second PUCCH repetitions without dropping (e.g., second/third PUCCH repetitions may be dropped due to collision with DL transmissions). In an example, the last transmission occasion (or repetition) of the third PUCCH occurs after the last symbol of the last transmission occasion (or repetition) of the second PUCCH but before the last symbol of the last transmission occasion (or repetition) of the first PUCCH. In an example, ‘x’ is larger than the number of second PUCCH repetitions (e.g., to increase the HP UCI reliability in case of multiplexing with LP UCI). In an example, ‘x’ is determined based on the HP UCI payload size and LP UCI payload size (e.g., ratio of HP UCI to LP UCI payload sizes).

In another implementation, the UE may determine the last transmission occasion (or repetition) of the third PUCCH based on a sub-slot of the second sub-slot length, where the last symbol of the first PUCCH (or the last symbol of the last transmission occasion (or repetition) of the first PUCCH) is located, when the first PUCCH ends later than the second PUCCH. That is, transmission of the third PUCCH may continue at least until the last symbol scheduled for LP UCI, in order to ensure enough transmission time for LP UCI. In another implementation, the UE may determine the last transmission occasion (or repetition) of the third PUCCH based on a sub-slot of the second sub-slot length, where the last symbol of the latest (e.g., last symbol of the PUCCH that ends later) from the first PUCCH and second PUCCH (or the last symbol of the last transmission occasion (or repetition) of the latest from the first PUCCH and second PUCCH first PUCCH) is located.

Repetition of the third PUCCH carrying UCI of mixed priorities over multiple sub-slots or slots, in one embodiment, can guarantee same or similar reliability as the second PUCCH carrying only HP UCI. Further, the UE can still meet latency requirement by completing at least one transmission of HP UCI before or within an originally scheduled sub-slot or slot (e.g., the sub-slot or slot where the second PUCCH is scheduled). The UE may be further configured or indicated (or provided) regarding which implementations described in the above the UE adopts to determine the initial and last transmission occasions (or repetitions) of the third PUCCH. In another example, one of the implementations described above is indicated by a UE capability signaling.

In one implementation, the UE may receive information of a first number, where the first number of PUCCH repetitions is applicable when multiplexing HP UCI with the LP UCI in a PUCCH resource. In another example, the set of possible first numbers is indicated by a UE capability signaling. In an example, the first number is indicated by RRC, MAC-CE or DCI signaling.

In another implementation, the UE may receive information of a first number and a second number and selects a repetition number from the first and second numbers based on a payload size of the LP UCI to be multiplexed, e.g., the first number of PUCCH repetition is applicable when the LP UCI is less than a threshold value, and the second number of PUCCH repetition is applicable when the LP UCI is equal to or larger than the threshold value. In an example, the threshold value is indicated via RRC, MAC-CE, and/or DCI/UE-capability signaling. In an example, the threshold value is indicated in the third/second/first PUCCH configuration.

In examples described below, a sub-slot length applied to a sub-slot is determined according to a PUCCH configuration associated with a PUCCH resource for HP SR.

In an example, if a UE transmits LP HARQ-ACK information bits in a first resource using PUCCH format 0 and transmits HP SR (e.g., positive SR) in a second resource using PUCCH format 0 in a slot/sub-slot, the UE may transmit the LP HARQ-ACK information bits (e.g., up to 2 bits) and the HP SR (e.g., positive SR) in the second resource using PUCCH format 0. The UE can implicitly indicate to a network entity that the multiplexed SR is a higher priority SR by multiplexing the HP SR and the LP HARQ-ACK into the second resource (e.g., the resource scheduled for the HP SR) instead of the first resource (e.g., the resource scheduled for the LP HARQ-ACK). Alternatively, the UE may transmit only the LP HARQ-ACK information bits in the second resource using PUCCH format 0. Further, the UE may perform repeated transmissions of a corresponding PUCCH of the second resource using PUCCH format 0 over a configured (or predefined, or dynamically indicated/determined) number of slots or sub-slots. For a negative SR, the UE transmits the LP HARQ-ACK information bits in the first resource using PUCCH format 0.

In an example, if a UE transmits HP SR (e.g., positive SR) in a resource using PUCCH format 0 and transmits LP HARQ-ACK information bits in a resource using PUCCH format 1 in a slot/sub-slot, the UE transmits the HP SR (e.g., positive SR) and the LP HARQ-ACK information bits in the resource using PUCCH format 0 and performs repeated transmissions of a corresponding PUCCH of the resource using PUCCH format 0 over a configured (or predefined, or dynamically indicated) number of slots/sub-slots. Alternatively, the UE may transmit only the LP HARQ-ACK information bits in the resource using PUCCH format 0 and performs repetition of the corresponding PUCCH of the resource using PUCCH format 0 over multiple slots/sub-slots. Note that the resource using PUCCH format 1 may start earlier than the sub-slot and/or may end later than the sub-slot.

In an example, if a UE transmits HP SR (e.g., positive SR) in a resource using PUCCH format 1 and transmits LP HARQ-ACK information bits in a resource using PUCCH format 0 in a slot/sub-slot, the UE transmits the LP HARQ-ACK information bits in the resource using PUCCH format 1. For a negative SR in the resource using PUCCH format 1, the UE transmits the LP HARQ-ACK information bits in the resource using PUCCH format 0. Note that the resource using PUCCH format 0 may start earlier than the sub-slot or may end later than the sub-slot.

In an example, if a UE transmits HP SR (e.g., positive SR) in a first resource using PUCCH format 1 and LP HARQ-ACK information bits in a second resource using PUCCH format 1 in a slot/sub-slot, the UE transmits the LP HARQ-ACK information bits in the first resource using PUCCH format 1. Further, if the second resource using PUCCH format 1 has longer duration than the first resource using PUCCH format 1, the UE may perform repeated transmissions of a corresponding PUCCH of the first resource using PUCCH format 1 over a configured (or predefined, or dynamically indicated/determined) number of slots or sub-slots. For a negative SR, the UE transmits the LP HARQ-ACK information bits in the second resource using PUCCH format 1.

In the examples described above, alternatively, the UE may transmit the HP SR and the LP HARQ-ACK information bits in a semi-statically configured or predefined PUCCH resource for UCI of mixed priorities up to 2 HARQ-ACK bits with a positive SR with PUCCH repetitions. In another alternative, the UE may transmit the HP SR and the LP HARQ-ACK information bits in a PUCCH resource determined by a PUCCH resource indication field of a last DCI format associated with the LP HARQ-ACK information bits, with PUCCH repetition.

In one embodiment, when a UE transmits LP UCI (e.g. including at least LP HARQ-ACK) in a first PUCCH and transmits HP UCI including at least HP HARQ-ACK feedback in response to a PDCCH (e.g., in response to a PDSCH reception with a corresponding PDCCH) in a second PUCCH overlapping with the first PUCCH in time, the UE determines a set of PUCCH resources based on O_{UCI} UCI bits of mixed priorities from a PUCCH configuration associated with a higher priority index (e.g., the second PUCCH-Config in Rel-16 NR). Further, the UE determines a PUCCH resource from the set of PUCCH resources, where the PUCCH resource is determined based on a PUCCH resource indicator field, if present, in a last DCI format indicating a higher priority index (e.g. the priority indicator field of the DCI format set to 1), among the DCI formats that have a value of a PDSCH-to-HARQ_feedback timing indicator field, if present, or a value of dl-DataToUL-ACK, or a value of dl-DataToUL-ACKForDC/Format1_2 for DCI format 1_2, indicating a same slot for the PUCCH transmission, that the UE detects and for which the UE transmits corresponding HARQ-ACK information in the PUCCH. If the last detected DCI format indicating the higher priority index does not include the PUCCH resource indicator field, the UE assumes that a value of the PUCCH resource indicator field is set to 0.

In one example, the UE determines the set of PUCCH resources by selecting a PUCCH resource set corresponding to O_{UCI} UCI bits of mixed priorities. In another example, the UE determines the set of PUCCH resources by selecting a PUCCH resource set corresponding to O′_{UCI} UCI bits of mixed priorities, where O′_{UCI} is smaller than O_{UCI} and the UE can obtain O′_{UCI} UCI bits of mixed priorities by compressing LP UCI bits or dropping (or omission) a part of LP UCI bits. In an example, the UE is not expected to multiplex LP UCI bits more than X % of HP UCI bits. In an example, X=100% (LP UCI bits being multiplexed in PUCCH resources of a PUCCH configuration associated with a high priority index are at most up to the HP UCI bits; the rest of LP UCI bits dropped, or the LP UCI bits are compressed and/or dropped to reach the allowed number of LP UCI bits for multiplexing.). in an example, ‘X’ is determined based on RRC signaling, UE capability signaling, etc.

In an implementation, for PUCCH resource determination, detected DCI formats are first indexed in an ascending order across serving cells indexes for a same PDCCH monitoring occasion and are then indexed in an ascending order across PDCCH monitoring occasion indexes.

For indexing DCI formats within a serving cell for a same PDCCH monitoring occasion, if the UE is not provided CORESETPoolIndex or is provided CORESETPoolIndex with value 0 for one or more first CORESETs and is provided CORESETPoolIndex with value 1 for one or more second CORESETs on an active DL BWP of a serving cell, and with ackNackFeedbackMode-r16=joint for the active UL BWP, detected DCI formats from PDCCH receptions in the first CORESETs are indexed prior to detected DCI formats from PDCCH receptions in the second CORESETs.

In an implementation, the PUCCH resource indicator field values map to values of a set of PUCCH resource indexes, e.g., as defined in Table 9.2.3-2 of 3GPP TS 38.213, for a

PUCCH resource indicator field of 3 bits, provided by resourceList for PUCCH resources from a set of PUCCH resources provided by PUCCH-ResourceSet with a maximum of eight PUCCH resources. If the PUCCH resource indicator field includes 1 bit or 2 bits, the values map to the first two values or the first four values, respectively, e.g., of Table 9.2.3-2 of 3GPP TS 38.213. If the last DCI format does not include a PUCCH resource indicator field, the first value of e.g., Table 9.2.3-2, is used.

In another embodiment, when a UE would transmit LP UCI including at least LP HARQ-ACK feedback in response to a PDCCH (e.g. in response to a PDSCH reception with a corresponding PDCCH) in a first PUCCH and would transmit HP UCI including HP HARQ-ACK feedback only for one or more SPS PDSCH receptions without corresponding PDCCHs in a second PUCCH overlapping with the first PUCCH in time, the UE determines a set of PUCCH resources based on O_{UCI} UCI bits of mixed priorities from a PUCCH configuration associated with a higher priority index (e.g. the second PUCCH-Config in Rel-16 NR). Further, the UE determines a PUCCH resource from the set of PUCCH resources where the PUCCH resource is determined based on a PUCCH resource indicator field, if present, in a last DCI format indicating a lower priority index (e.g. the priority indicator field of the DCI format set to 0), among the DCI formats that have a value of a PDSCH-to-HARQ_feedback timing indicator field, if present, or a value of dl-DataToUL-ACK, or a value of dl-DataToUL-ACKForDCIFormat1_2 for DCI format 1_2, indicating a same slot for the PUCCH transmission, that the UE detects and for which the UE transmits corresponding HARQ-ACK information in the PUCCH. If the last detected DCI format indicating the higher priority index does not include the PUCCH resource indicator field, the UE assumes that a value of the PUCCH resource indicator field is set to 0.

In an implementation, a UE may receive information of a list of PUCCH resources for each PUCCH resource set of one or more PUCCH resource sets, which are used for UCI with mixed priorities, in a PUCCH configuration associated with a higher priority index (e.g., the second PUCCH-Config in Rel-16 NR). As shown in Example 1 below, in one example, if the UE determines to multiplex UCI of mixed priorities in a PUCCH resource and if a DCI format with a priority indicator field value of 0 is a last DCI format to determine the PUCCH resource, the UE uses the information of the list of PUCCH resources, e.g., indicated via a higher-layer parameter resourceListMixedPriorities-r17, to determine the PUCCH resource.

### Example 1

Mapping of PUCCH resource indication (PRI) field values in a DCI format with a priority indicator field value of 0 to a PUCCH resource in a PUCCH resource set with maximum 8 PUCCH resources, when the DCI format determines a PUCCH resource for UCI with mixed priorities

| PUCCH resource indicator | | | |
|---|---|---|---|
| 1 bit | 2 bits | 3 bits | PUCCH resource |
| ‘O’ | ‘00’ | ‘000’ | 1^{st} PUCCH resource provided by |
| | | | pucch-ResourceId |
| | | | obtained from the 1^{st} value of |
| | | | resourceListMixedPriorities-r17 |
| ‘1' | ‘01’ | ‘001’ | 2^{nd} PUCCH resource provided by |
| | | | pucch-ResourceId |
| | | | obtained from the 2^{nd} value of |
| | | | resourceListMixedPriorities-r17 |
| | ‘10’ | ‘010’ | 3^{rd} PUCCH resource provided by |
| | | | pucch-ResourceId |
| | | | obtained from the 3^{rd} value of |
| | | | resourceListMixedPriorities-r17 |
| | ‘11’ | ‘011’ | 4^{th} PUCCH resource provided by |
| | | | pucch-ResourceId |
| | | | obtained from the 4^{th} value of |
| | | | resourceListMixedPriorities-r17 |
| | | ‘100’ | 5^{th} PUCCH resource provided by |
| | | | pucch-ResourceId |
| | | | obtained from the 5^{th} value of |
| | | | resourceListMixedPriorities-r17 |
| | | ‘101’ | 6^{th} PUCCH resource provided by |
| | | | pucch-ResourceId |
| | | | obtained from the 6^{th} value of |
| | | | resourceListMixedPriorities-r17 |
| | | ‘110’ | 7th PUCCH resource provided by |
| | | | pucch-ResourceId |
| | | | obtained from the 7^{th} value of |
| | | | resourceListMixedPriorities-r17 |
| | | ‘111’ | 8th PUCCH resource provided by |
| | | | pucch-ResourceId |
| | | | obtained from the 8^{th} value of |
| | | | resourceListMixedPriorities-r17 |

In other embodiments, a UE may receive information of a list of semi-statically configured PUCCH resources, which are used for UCI with mixed priorities if no DCI format requiring a HARQ-ACK feedback is detected, in a PUCCH configuration associated with a higher priority index (e.g., the second PUCCH-Config in Rel-16 NR). When the UE transmits LP HARQ-ACK feedback only for one or more SPS PDSCH receptions without corresponding PDCCHs in a first PUCCH and transmits HP UCI including HP HARQ-ACK feedback only for one or more SPS PDSCH receptions without corresponding PDCCHs and/or including one or more HP SRs in a second PUCCH overlapping with the first PUCCH in time, the UE determines a PUCCH resource based on O_{UCI} UCI bits of mixed priorities from the list of semi-statically configured PUCCH resources. In an example, whether the LP UCI bits associated with a SPS configuration can be multiplexed into a PUCCH resource associated with a higher priority index is configured per SPS configuration.

In one embodiment, a UE is configured with more than one PUCCH configurations

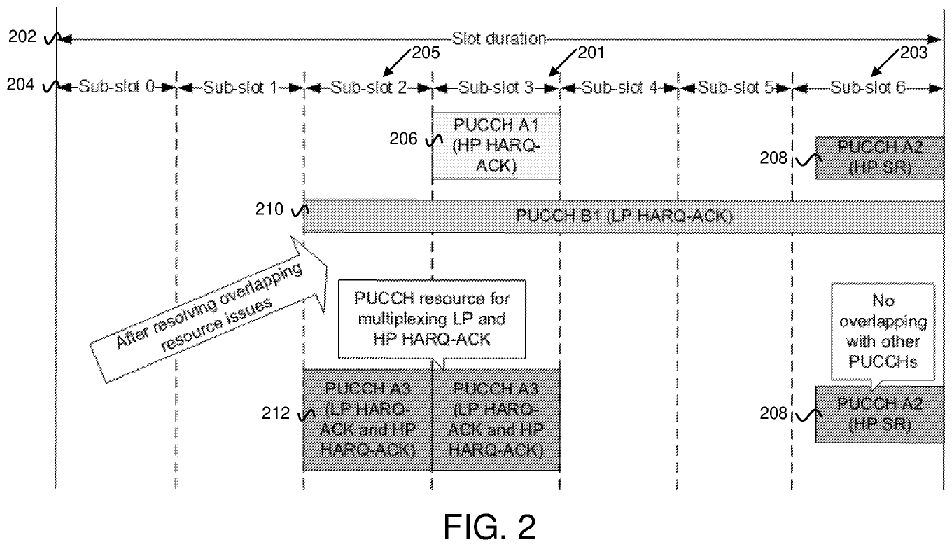

in a given UL BWP, e.g., a first PUCCH configuration with a first slot/sub-slot length and a lower priority index and a second PUCCH configuration with a second slot/sub-slot length and a higher priority index, the UE handles overlapping PUCCH or PUSCH resources of different priority indices in per sub-slot basis, where a sub-slot is defined according to the second PUCCH configuration of the second sub-slot length. For example, as shown in FIG. 2, the first PUCCH configuration includes slot-based PUCCH resources (e.g., slot duration 202 of 14 symbols) and the second PUCCH configuration includes sub-slot 204 based PUCCH resources with a sub-slot length of 2 symbols. The UE checks and handles overlapping PUCCH or PUSCH resources for each sub-slot 204 of the second PUCCH configuration.

If the UE transmits PUCCH A1 206 including HP HARQ-ACK, PUCCH A2 208 including HP SR, and PUCCH B1 210 including LP HARQ-ACK, the UE has overlapping PUCCHs in sub-slot 3 201 and sub-slot 6 203. First, the UE resolves the overlapping in sub-slot 3 201 by multiplexing HP HARQ-ACK and LP HARQ-ACK into PUCCH A3 212 that is selected from PUCCH resources of the second PUCCH configuration and is repeated over two sub-slots 204 (sub-slot 2 205 and sub-slot 3 201). Since the UE determines not to transmit PUCCH B1 210 after resolving the overlapping PUCCH resources (e.g., PUCCH A1 206 and PUCCH B1210), the UE can transmit PUCCH A2 208 in sub-slot 6 203.

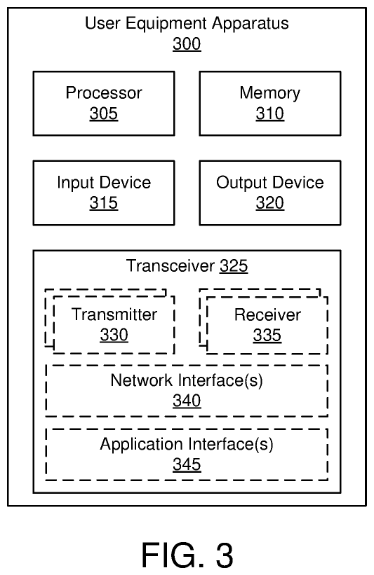

FIG. 3 depicts a user equipment apparatus 300 that may be used for enhanced multiplexing of uplink control information of different priorities, according to embodiments of the disclosure. In various embodiments, the user equipment apparatus 300 is used to implement one or more of the solutions described above. The user equipment apparatus 300 may be one embodiment of the remote unit 105 and/or the UE 305, described above. Furthermore, the user equipment apparatus 300 may include a processor 305, a memory 310, an input device 315, an output device 320, and a transceiver 325.

In some embodiments, the input device 315 and the output device 320 are combined into a single device, such as a touchscreen. In certain embodiments, the user equipment apparatus 300 may not include any input device 315 and/or output device 320. In various embodiments, the user equipment apparatus 300 may include one or more of: the processor 305, the memory 310, and the transceiver 325, and may not include the input device 315 and/or the output device 320.

As depicted, the transceiver 325 includes at least one transmitter 330 and at least one receiver 335. In some embodiments, the transceiver 325 communicates with one or more cells (or wireless coverage areas) supported by one or more base units 121. In various embodiments, the transceiver 325 is operable on unlicensed spectrum. Moreover, the transceiver 325 may include multiple UE panel supporting one or more beams. Additionally, the transceiver 325 may support at least one network interface 340 and/or application interface 345. The application interface(s) 345 may support one or more APIs. The network interface(s) 340 may support 3GPP reference points, such as Uu, N1, PC5, etc. Other network interfaces 340 may be supported, as understood by one of ordinary skill in the art.

The processor 305, in one embodiment, may include any known controller capable

of executing computer-readable instructions and/or capable of performing logical operations. For example, the processor 305 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 305 executes instructions stored in the memory 310 to perform the methods and routines described herein. The processor 305 is communicatively coupled to the memory 310, the input device 315, the output device 320, and the transceiver 325. In certain embodiments, the processor 305 may include an application processor (also known as “main processor”) which manages application-domain and operating system (“OS”) functions and a baseband processor (also known as “baseband radio processor”) which manages radio functions.

In one embodiment, the processor 305 determines a first transmission of first uplink control information (“UCI”) on a first physical uplink control channel (“PUCCH”), the first PUCCH having a first priority. In one embodiment, the processor 305 determines a second transmission of second UCI on a second PUCCH, the second PUCCH overlapping the first PUCCH in time and having a second priority that is higher than the first priority of the first PUCCH.

In one embodiment, the processor 305 determines a set of PUCCH resources based on UCI bits of the first and second priorities from a PUCCH configuration associated with the second PUCCH, wherein the UCI bits of the first and second priorities are selected from the first and second UCI. In one embodiment, the processor 305 determines a third PUCCH based on a PUCCH resource of the set of PUCCH resources, the PUCCH resource determined based on a downlink control information (“DCI”) format among detected one or more DCI formats indicating the second priority and a slot of the second PUCCH transmission. In one embodiment, the processor 305 multiplexes the UCI bits of the first and second priorities on the third PUCCH for transmission in the indicated slot.

In one embodiment, the DCI format is a last DCI format among the detected one or more DCI formats, wherein the detected one or more DCI formats request hybrid automatic repeat request-acknowledgment (“HARQ-ACK”) feedback and are first indexed in an ascending order across serving cells indexes for a same PDCCH monitoring occasion and are then indexed in an ascending order across PDCCH monitoring occasion indexes.

In one embodiment, the PUCCH resource is determined based on a PUCCH resource indicator field in the last DCI format.

In one embodiment, the processor 305 presumes the PUCCH resource indicator field is set to ‘0’ in response to the last DCI format not comprising the PUCCH resource indicator field.

In one embodiment, the PUCCH configuration associated with the second PUCCH comprises a sub-slot length, wherein a duration of the slot is equal to the configured sub-slot length.

In one embodiment, the UCI bits of the first and second priorities comprise HARQ-ACK information of the first priority and HARQ-ACK information of the second priority.

In one embodiment, the transceiver 325 transmits the third PUCCH, wherein the third PUCCH comprises a plurality of repetitions on a plurality of transmission occasions.

In one embodiment, an initial transmission occasion of the third PUCCH is determined based on a slot where an earliest symbol from the first PUCCH and the second PUCCH is located.

In one embodiment, a last transmission occasion of the third PUCCH is determined based on the slot where the second PUCCH is located.

In one embodiment, the transceiver 325 receives a first PUCCH configuration and a second PUCCH configuration, the first PUCCH configured using the first PUCCH configuration and the second PUCCH and the third PUCCH configured using the second PUCCH configuration.

In one embodiment, the third PUCCH has a same priority as the second PUCCH and the set of PUCCH resources is determined based on a size of the UCI bits of the first and second priorities.

In one embodiment, the processor 305 determines a third transmission of third UCI on a fourth PUCCH, the fourth PUCCH overlapping the first PUCCH in time, having the second priority, and being in a slot later than the slot of the second PUCCH transmission. In one embodiment, the transceiver 325 transmits the UCI bits of the first and second priorities on the third PUCCH and transmitting the third UCI on the fourth PUCCH.

The memory 310, in one embodiment, is a computer readable storage medium. In some embodiments, the memory 310 includes volatile computer storage media. For example, the memory 310 may include a RAM, including dynamic RAM (“DRAM”), synchronous dynamic RAM (“SDRAM”), and/or static RAM (“SRAM”). In some embodiments, the memory 310 includes non-volatile computer storage media. For example, the memory 310 may include a hard disk drive, a flash memory, or any other suitable non-volatile computer storage device. In some embodiments, the memory 310 includes both volatile and non-volatile computer storage media.

In some embodiments, the memory 310 stores data related to enhanced multiplexing of uplink control information of different priorities. For example, the memory 310 may store various parameters, panel/beam configurations, resource assignments, policies, and the like, as described above. In certain embodiments, the memory 310 also stores program code and related data, such as an operating system or other controller algorithms operating on the user equipment apparatus 300.

The input device 315, in one embodiment, may include any known computer input device including a touch panel, a button, a keyboard, a stylus, a microphone, or the like. In some embodiments, the input device 315 may be integrated with the output device 320, for example, as a touchscreen or similar touch-sensitive display. In some embodiments, the input device 315 includes a touchscreen such that text may be input using a virtual keyboard displayed on the touchscreen and/or by handwriting on the touchscreen. In some embodiments, the input device 315 includes two or more different devices, such as a keyboard and a touch panel.

The output device 320, in one embodiment, is designed to output visual, audible, and/or haptic signals. In some embodiments, the output device 320 includes an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the user equipment apparatus 300, such as a smart watch, smart glasses, a heads-up display, or the like. Further, the output device 320 may be a component of a smart phone, a personal digital assistant, a television, a tablet computer, a notebook (laptop) computer, a personal computer, a vehicle dashboard, or the like.

In certain embodiments, the output device 320 includes one or more speakers for producing sound. For example, the output device 320 may produce an audible alert or notification (e.g., a beep or chime). In some embodiments, the output device 320 includes one or more haptic devices for producing vibrations, motion, or other haptic feedback. In some embodiments, all, or portions of the output device 320 may be integrated with the input device 315. For example, the input device 315 and output device 320 may form a touchscreen or similar touch-sensitive display. In other embodiments, the output device 320 may be located near the input device 315.

The transceiver 325 communicates with one or more network functions of a mobile communication network via one or more access networks. The transceiver 325 operates under the control of the processor 305 to transmit messages, data, and other signals and also to receive messages, data, and other signals. For example, the processor 305 may selectively activate the transceiver 325 (or portions thereof) at particular times in order to send and receive messages.

The transceiver 325 includes at least transmitter 330 and at least one receiver 335. One or more transmitters 330 may be used to provide UL communication signals to a base unit 121, such as the UL transmissions described herein. Similarly, one or more receivers 335 may be used to receive DL communication signals from the base unit 121, as described herein. Although only one transmitter 330 and one receiver 335 are illustrated, the user equipment apparatus 300 may have any suitable number of transmitters 330 and receivers 335. Further, the transmitter(s) 330 and the receiver(s) 335 may be any suitable type of transmitters and receivers. In one embodiment, the transceiver 325 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 325, transmitters 330, and receivers 335 may be implemented as physically separate components that access a shared hardware resource and/or software resource, such as for example, the network interface 340.

In various embodiments, one or more transmitters 330 and/or one or more receivers 335 may be implemented and/or integrated into a single hardware component, such as a multi-transceiver chip, a system-on-a-chip, an ASIC, or other type of hardware component. In certain embodiments, one or more transmitters 330 and/or one or more receivers 335 may be implemented and/or integrated into a multi-chip module. In some embodiments, other components such as the network interface 340 or other hardware components/circuits may be integrated with any number of transmitters 330 and/or receivers 335 into a single chip. In such embodiment, the transmitters 330 and receivers 335 may be logically configured as a transceiver 325 that uses one more common control signals or as modular transmitters 330 and receivers 335 implemented in the same hardware chip or in a multi-chip module.

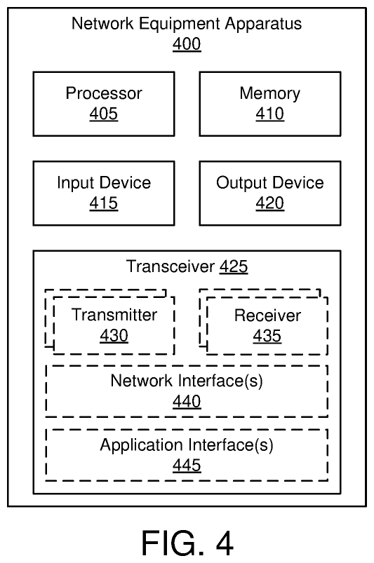

FIG. 4 depicts a network apparatus 400 that may be used for enhanced multiplexing of uplink control information of different priorities, according to embodiments of the disclosure. In one embodiment, network apparatus 400 may be one implementation of a RAN node, such as the base unit 121, the RAN node 210, or gNB, described above. Furthermore, the base network apparatus 400 may include a processor 405, a memory 410, an input device 415, an output device 420, and a transceiver 425.

In some embodiments, the input device 415 and the output device 420 are combined into a single device, such as a touchscreen. In certain embodiments, the network apparatus 400 may not include any input device 415 and/or output device 420. In various embodiments, the network apparatus 400 may include one or more of: the processor 405, the memory 410, and the transceiver 425, and may not include the input device 415 and/or the output device 420.

As depicted, the transceiver 425 includes at least one transmitter 430 and at least one receiver 435. Here, the transceiver 425 communicates with one or more remote units 105. Additionally, the transceiver 425 may support at least one network interface 440 and/or application interface 445. The application interface(s) 445 may support one or more. The network interface(s) 440 may support 3GPP reference points, such as Uu, N1, N2 and N3. Other network interfaces 440 may be supported, as understood by one of ordinary skill in the art.

The processor 405, in one embodiment, may include any known controller capable of executing computer-readable instructions and/or capable of performing logical operations. For example, the processor 405 may be a microcontroller, a microprocessor, a CPU, a GPU, an auxiliary processing unit, a FPGA, or similar programmable controller. In some embodiments, the processor 405 executes instructions stored in the memory 410 to perform the methods and routines described herein. The processor 405 is communicatively coupled to the memory 410, the input device 415, the output device 420, and the transceiver 425. In certain embodiments, the processor 405 may include an application processor (also known as “main processor”) which manages application-domain and operating system (“OS”) functions and a baseband processor (also known as “baseband radio processor”) which manages radio function.

In various embodiments, the network apparatus 400 is a RAN node (e.g., gNB) that includes a processor 405 and a transceiver 425. In one embodiment, the processor 405 schedules a first transmission of first uplink control information (“UCI”) on a first physical uplink control channel (“PUCCH”) by a user equipment (“UE”), the first PUCCH having a first priority. In one embodiment, the processor 405 schedules a second transmission of second UCI on a second PUCCH by the UE, the second PUCCH overlapping the first PUCCH in time and having a second priority that is higher than the first priority of the first PUCCH.

In one embodiment, the processor 405 selects a PUCCH resource from a set of PUCCH resources for a third PUCCH, wherein the set of PUCCH resources from a PUCCH configuration associated with the second PUCCH is based on UCI bits of the first and second priorities selected from the first and second UCI. In one embodiment, the processor 405 indicates the PUCCH resource of the set of PUCCH resources in a downlink control information (“DCI”) format among transmitted one or more DCI formats indicating the second priority and a slot of the second PUCCH transmission. In one embodiment, the transceiver 425 receives the third PUCCH in the indicated slot.

The memory 410, in one embodiment, is a computer readable storage medium. In some embodiments, the memory 410 includes volatile computer storage media. For example, the memory 410 may include a RAM, including dynamic RAM (“DRAM”), synchronous dynamic RAM (“SDRAM”), and/or static RAM (“SRAM”). In some embodiments, the memory 410 includes non-volatile computer storage media. For example, the memory 410 may include a hard disk drive, a flash memory, or any other suitable non-volatile computer storage device. In some embodiments, the memory 410 includes both volatile and non-volatile computer storage media.

In some embodiments, the memory 410 stores data related to enhanced multiplexing of uplink control information of different priorities. For example, the memory 410 may store parameters, configurations, resource assignments, policies, and the like, as described above. In certain embodiments, the memory 410 also stores program code and related data, such as an operating system or other controller algorithms operating on the network apparatus 400.

The input device 415, in one embodiment, may include any known computer input device including a touch panel, a button, a keyboard, a stylus, a microphone, or the like. In some embodiments, the input device 415 may be integrated with the output device 420, for example, as a touchscreen or similar touch-sensitive display. In some embodiments, the input device 415 includes a touchscreen such that text may be input using a virtual keyboard displayed on the touchscreen and/or by handwriting on the touchscreen. In some embodiments, the input device 415 includes two or more different devices, such as a keyboard and a touch panel.

The output device 420, in one embodiment, is designed to output visual, audible, and/or haptic signals. In some embodiments, the output device 420 includes an electronically controllable display or display device capable of outputting visual data to a user. For example, the output device 420 may include, but is not limited to, an LCD display, an LED display, an OLED display, a projector, or similar display device capable of outputting images, text, or the like to a user. As another, non-limiting, example, the output device 420 may include a wearable display separate from, but communicatively coupled to, the rest of the network apparatus 400, such as a smart watch, smart glasses, a heads-up display, or the like. Further, the output device 420 may be a component of a smart phone, a personal digital assistant, a television, a tablet computer, a notebook (laptop) computer, a personal computer, a vehicle dashboard, or the like.

In certain embodiments, the output device 420 includes one or more speakers for producing sound. For example, the output device 420 may produce an audible alert or notification (e.g., a beep or chime). In some embodiments, the output device 420 includes one or more haptic devices for producing vibrations, motion, or other haptic feedback. In some embodiments, all, or portions of the output device 420 may be integrated with the input device 415. For example, the input device 415 and output device 420 may form a touchscreen or similar touch-sensitive display. In other embodiments, the output device 420 may be located near the input device 415.

The transceiver 425 includes at least transmitter 430 and at least one receiver 435. One or more transmitters 430 may be used to communicate with the UE, as described herein. Similarly, one or more receivers 435 may be used to communicate with network functions in the NPN, PLMN and/or RAN, as described herein. Although only one transmitter 430 and one receiver 435 are illustrated, the network apparatus 400 may have any suitable number of transmitters 430 and receivers 435. Further, the transmitter(s) 430 and the receiver(s) 435 may be any suitable type of transmitters and receivers.

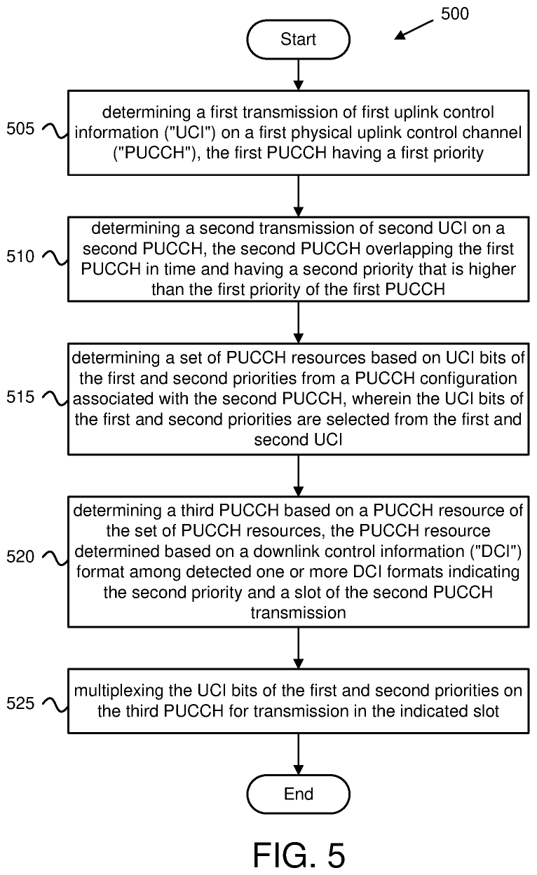

FIG. 5 is a flowchart diagram of a method 500 for enhanced multiplexing of uplink control information of different priorities. The method 500 may be performed by a UE as described herein, for example, the remote unit 105, the UE 205 and/or the user equipment apparatus 300. In some embodiments, the method 500 may be performed by a processor executing program code, for example, a microcontroller, a microprocessor, a CPU, a GPU, an auxiliary processing unit, a FPGA, or the like.

In one embodiment, the method 500 includes determining 505 a first transmission of first uplink control information (“UCI”) on a first physical uplink control channel (“PUCCH”), the first PUCCH having a first priority. In one embodiment, the method 500 includes determining 510 a second transmission of second UCI on a second PUCCH, the second PUCCH overlapping the first PUCCH in time and having a second priority that is higher than the first priority of the first PUCCH.

In one embodiment, the method 500 includes determining 515 a set of PUCCH resources based on UCI bits of the first and second priorities from a PUCCH configuration associated with the second PUCCH, wherein the UCI bits of the first and second priorities are selected from the first and second UCI. In one embodiment, the method 500 includes determining 520 a third PUCCH based on a PUCCH resource of the set of PUCCH resources, the PUCCH resource determined based on a downlink control information (“DCI”) format among detected one or more DCI formats indicating the second priority and a slot of the second PUCCH transmission. In one embodiment, the method 500 includes multiplexing 525 the UCI bits of the first and second priorities on the third PUCCH for transmission in the indicated slot. The method 500 ends.

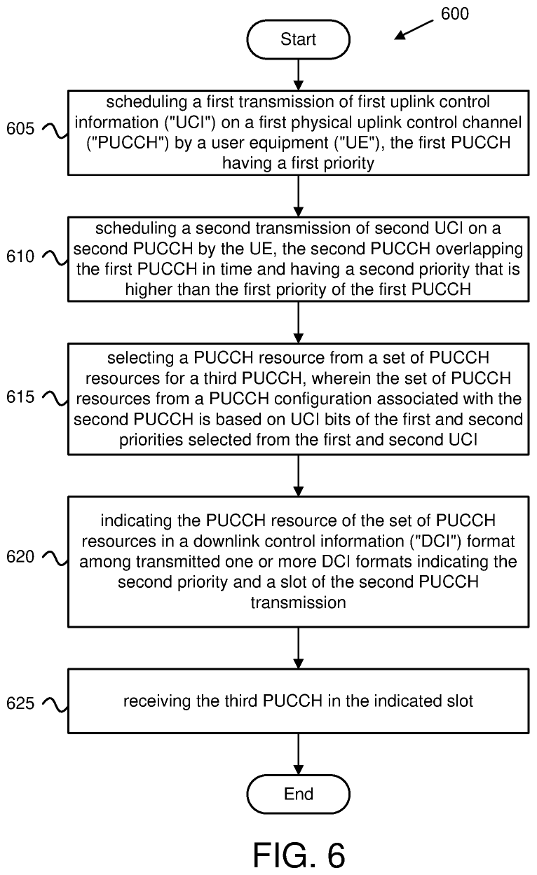

FIG. 6 is a flowchart diagram of a method 600 for enhanced multiplexing of uplink control information of different priorities. The method 600 may be performed by a network device as described herein, for example, a RAN node, a gNB, and/or the network equipment apparatus 400. In some embodiments, the method 600 may be performed by a processor executing program code, for example, a microcontroller, a microprocessor, a CPU, a GPU, an auxiliary processing unit, a FPGA, or the like.

The method 600 scheduling 605 a first transmission of first uplink control information (“UCI”) on a first physical uplink control channel (“PUCCH”) by a user equipment (“UE”), the first PUCCH having a first priority. In one embodiment, the method 600 includes scheduling 610 a second transmission of second UCI on a second PUCCH by the UE, the second PUCCH overlapping the first PUCCH in time and having a second priority that is higher than the first priority of the first PUCCH.

In one embodiment, the method 600 includes selecting 615 a PUCCH resource from a set of PUCCH resources for a third PUCCH, wherein the set of PUCCH resources from a PUCCH configuration associated with the second PUCCH is based on UCI bits of the first and second priorities selected from the first and second UCI. In one embodiment, the method 600 includes indicating 620 the PUCCH resource of the set of PUCCH resources in a downlink control information (“DCI”) format among transmitted one or more DCI formats indicating the second priority and a slot of the second PUCCH transmission. In one embodiment, the method 600 includes receiving the third PUCCH in the indicated slot. The method 600 ends.

Disclosed herein is a first apparatus for enhanced multiplexing of uplink control information of different priorities. The first apparatus may include a UE as described herein, for example, the remote unit 105, the UE 205 and/or the user equipment apparatus 300. In some embodiments, the first apparatus includes a processor executing program code, for example, a microcontroller, a microprocessor, a CPU, a GPU, an auxiliary processing unit, a FPGA, or the like.

In one embodiment, the first apparatus includes a processor that determines a first transmission of first uplink control information (“UCI”) on a first physical uplink control channel (“PUCCH”), the first PUCCH having a first priority. In one embodiment, the processor determines a second transmission of second UCI on a second PUCCH, the second PUCCH overlapping the first PUCCH in time and having a second priority that is higher than the first priority of the first PUCCH.

In one embodiment, the processor determines a set of PUCCH resources based on UCI bits of the first and second priorities from a PUCCH configuration associated with the second PUCCH, wherein the UCI bits of the first and second priorities are selected from the first and second UCI. In one embodiment, the processor determines a third PUCCH based on a PUCCH resource of the set of PUCCH resources, the PUCCH resource determined based on a downlink control information (“DCI”) format among detected one or more DCI formats indicating the second priority and a slot of the second PUCCH transmission. In one embodiment, the processor multiplexes the UCI bits of the first and second priorities on the third PUCCH for transmission in the indicated slot.

In one embodiment, the DCI format is a last DCI format among the detected one or more DCI formats, wherein the detected one or more DCI formats request hybrid automatic repeat request-acknowledgment (“HARQ-ACK”) feedback and are first indexed in an ascending order across serving cells indexes for a same PDCCH monitoring occasion and are then indexed in an ascending order across PDCCH monitoring occasion indexes.

In one embodiment, the PUCCH resource is determined based on a PUCCH resource indicator field in the last DCI format.

In one embodiment, the processor presumes the PUCCH resource indicator field is set to ‘0’ in response to the last DCI format not comprising the PUCCH resource indicator field.

In one embodiment, the PUCCH configuration associated with the second PUCCH comprises a sub-slot length, wherein a duration of the slot is equal to the configured sub-slot length.

In one embodiment, the UCI bits of the first and second priorities comprise HARQ-ACK information of the first priority and HARQ-ACK information of the second priority.

In one embodiment, the first apparatus includes a transceiver that transmits the third PUCCH, wherein the third PUCCH comprises a plurality of repetitions on a plurality of transmission occasions.

In one embodiment, an initial transmission occasion of the third PUCCH is determined based on a slot where an earliest symbol from the first PUCCH and the second PUCCH is located.

In one embodiment, a last transmission occasion of the third PUCCH is determined based on the slot where the second PUCCH is located.

In one embodiment, the first apparatus includes a transceiver that receives a first PUCCH configuration and a second PUCCH configuration, the first PUCCH configured using the first PUCCH configuration and the second PUCCH and the third PUCCH configured using the second PUCCH configuration.

In one embodiment, the third PUCCH has a same priority as the second PUCCH and the set of PUCCH resources is determined based on a size of the UCI bits of the first and second priorities.

In one embodiment, the processor determines a third transmission of third UCI on a fourth PUCCH, the fourth PUCCH overlapping the first PUCCH in time, having the second priority, and being in a slot later than the slot of the second PUCCH transmission. In one embodiment, the first apparatus includes a transceiver that transmits the UCI bits of the first and second priorities on the third PUCCH and transmitting the third UCI on the fourth PUCCH.

Disclosed herein is a first method for enhanced multiplexing of uplink control information of different priorities. The first method may be performed by a UE as described herein, for example, the remote unit 105, the UE 205 and/or the user equipment apparatus 300. In some embodiments, the first method may be performed by a processor executing program code, for example, a microcontroller, a microprocessor, a CPU, a GPU, an auxiliary processing unit, a FPGA, or the like.

In one embodiment, the first method includes determining a first transmission of first uplink control information (“UCI”) on a first physical uplink control channel (“PUCCH”), the first PUCCH having a first priority. In one embodiment, the first method includes determining a second transmission of second UCI on a second PUCCH, the second PUCCH overlapping the first PUCCH in time and having a second priority that is higher than the first priority of the first PUCCH.

In one embodiment, the first method includes determining a set of PUCCH resources based on UCI bits of the first and second priorities from a PUCCH configuration associated with the second PUCCH, wherein the UCI bits of the first and second priorities are selected from the first and second UCI. In one embodiment, the first method includes determining a third PUCCH based on a PUCCH resource of the set of PUCCH resources, the PUCCH resource determined based on a downlink control information (“DCI”) format among detected one or more DCI formats indicating the second priority and a slot of the second PUCCH transmission. In one embodiment, the first method includes multiplexing the UCI bits of the first and second priorities on the third PUCCH for transmission in the indicated slot.

In one embodiment, the DCI format is a last DCI format among the detected one or more DCI formats, wherein the detected one or more DCI formats request hybrid automatic repeat request-acknowledgment (“HARQ-ACK”) feedback and are first indexed in an ascending order across serving cells indexes for a same PDCCH monitoring occasion and are then indexed in an ascending order across PDCCH monitoring occasion indexes.

In one embodiment, the PUCCH resource is determined based on a PUCCH resource indicator field in the last DCI format.

In one embodiment, the first method includes presuming the PUCCH resource indicator field is set to ‘0’ in response to the last DCI format not comprising the PUCCH resource indicator field.

In one embodiment, the PUCCH configuration associated with the second PUCCH

comprises a sub-slot length, wherein a duration of the slot is equal to the configured sub-slot length.

In one embodiment, the UCI bits of the first and second priorities comprise HARQ-ACK information of the first priority and HARQ-ACK information of the second priority.

In one embodiment, the first method includes transmitting the third PUCCH, wherein the third PUCCH comprises a plurality of repetitions on a plurality of transmission occasions.

In one embodiment, an initial transmission occasion of the third PUCCH is determined based on a slot where an earliest symbol from the first PUCCH and the second PUCCH is located.

In one embodiment, a last transmission occasion of the third PUCCH is determined based on the slot where the second PUCCH is located.

In one embodiment, the first method includes receiving a first PUCCH configuration and a second PUCCH configuration, the first PUCCH configured using the first PUCCH configuration and the second PUCCH and the third PUCCH configured using the second PUCCH configuration.

In one embodiment, the third PUCCH has a same priority as the second PUCCH and the set of PUCCH resources is determined based on a size of the UCI bits of the first and second priorities.

In one embodiment, the first method includes determining a third transmission of third UCI on a fourth PUCCH, the fourth PUCCH overlapping the first PUCCH in time, having the second priority, and being in a slot later than the slot of the second PUCCH transmission. In one embodiment, the first method includes transmitting the UCI bits of the first and second priorities on the third PUCCH and transmitting the third UCI on the fourth PUCCH.

Disclosed herein is a second apparatus for enhanced multiplexing of uplink control information of different priorities. The second apparatus may include a network device as described herein, for example, a RAN node, a gNB, and/or the network equipment apparatus 400. In some embodiments, the second apparatus may include a processor executing program code, for example, a microcontroller, a microprocessor, a CPU, a GPU, an auxiliary processing unit, a FPGA, or the like.

In one embodiment, the second apparatus includes a processor that schedules a first transmission of first uplink control information (“UCI”) on a first physical uplink control channel (“PUCCH”) by a user equipment (“UE”), the first PUCCH having a first priority. In one embodiment, the processor schedules a second transmission of second UCI on a second PUCCH by the UE, the second PUCCH overlapping the first PUCCH in time and having a second priority that is higher than the first priority of the first PUCCH.

In one embodiment, the processor selects a PUCCH resource from a set of PUCCH resources for a third PUCCH, wherein the set of PUCCH resources from a PUCCH configuration associated with the second PUCCH is based on UCI bits of the first and second priorities selected from the first and second UCI. In one embodiment, the processor indicates the PUCCH resource of the set of PUCCH resources in a downlink control information (“DCI”) format among transmitted one or more DCI formats indicating the second priority and a slot of the second PUCCH transmission. In one embodiment, the second apparatus includes a transceiver that receives the third PUCCH in the indicated slot.

In one embodiment, the DCI format is a last DCI format among the transmitted one or more DCI formats, wherein the transmitted one or more DCI formats request hybrid automatic repeat request-acknowledgment (“HARQ-ACK”) feedback from the UE and are first indexed in an ascending order across serving cells indexes for a same PDCCH monitoring occasion for the UE and are then indexed in an ascending order across PDCCH monitoring occasion indexes for the UE.

Disclosed herein is a second method for enhanced multiplexing of uplink control information of different priorities. The second method may be performed by a network device as described herein, for example, a RAN node, a gNB, and/or the network equipment apparatus 400. In some embodiments, the second method may be performed by a processor executing program code, for example, a microcontroller, a microprocessor, a CPU, a GPU, an auxiliary processing unit, a FPGA, or the like.

In one embodiment, the second method includes scheduling a first transmission of first uplink control information (“UCI”) on a first physical uplink control channel (“PUCCH”) by a user equipment (“UE”), the first PUCCH having a first priority. In one embodiment, the second method includes scheduling a second transmission of second UCI on a second PUCCH by the UE, the second PUCCH overlapping the first PUCCH in time and having a second priority that is higher than the first priority of the first PUCCH.

In one embodiment, the second method includes selecting a PUCCH resource from a set of PUCCH resources for a third PUCCH, wherein the set of PUCCH resources from a PUCCH configuration associated with the second PUCCH is based on UCI bits of the first and second priorities selected from the first and second UCI. In one embodiment, the second method includes indicating the PUCCH resource of the set of PUCCH resources in a downlink control information (“DCI”) format among transmitted one or more DCI formats indicating the second priority and a slot of the second PUCCH transmission. In one embodiment, the second method includes receiving the third PUCCH in the indicated slot.

In one embodiment, the DCI format is a last DCI format among the transmitted one or more DCI formats, wherein the transmitted one or more DCI formats request hybrid automatic repeat request-acknowledgment (“HARQ-ACK”) feedback from the UE and are first indexed in an ascending order across serving cells indexes for a same PDCCH monitoring occasion for the UE and are then indexed in an ascending order across PDCCH monitoring occasion indexes for the UE.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (“UE”) for wireless communication, comprising:
at least one memory; and
at least one processor coupled with the at least one memory and configured to cause the UE to:
determine a first transmission of first uplink control information (“UCI”) on a first physical uplink control channel (“PUCCH”), the first PUCCH having a first priority;
determine a second transmission of second UCI on a second PUCCH, the second PUCCH overlapping the first PUCCH in time and having a second priority that is higher than the first priority of the first PUCCH;
determine a set of PUCCH resources based on UCI bits of the first and second priorities from a PUCCH configuration associated with the second PUCCH, wherein the UCI bits of the first and second priorities are selected from the first and second UCI;
determine a third PUCCH based on a PUCCH resource of the set of PUCCH resources, wherein the PUCCH resource is determined based on a downlink control information (“DCI”) format of detected one or more DCI formats indicating the second priority and a slot of the second PUCCH transmission; and
multiplex the UCI bits of the first and second priorities on the third PUCCH for transmission in the indicated slot.

2. The UE of claim 1, wherein the DCI format is a last DCI format among the detected one or more DCI formats, wherein the detected one or more DCI formats request hybrid automatic repeat request-acknowledgment (“HARQ-ACK”) feedback and are first indexed in an ascending order across serving cells indexes for a same PDCCH monitoring occasion and are then indexed in an ascending order across PDCCH monitoring occasion indexes.

3. The UE of claim 2, wherein the PUCCH resource is determined based on a PUCCH resource indicator field in the last DCI format.

4. The UE of claim 3, wherein the at least one processor is configured to cause the UE to presume the PUCCH resource indicator field is set to ‘0’ in response to the last DCI format not comprising the PUCCH resource indicator field.

5. The UE of claim 1, wherein the PUCCH configuration associated with the second PUCCH comprises a sub-slot length, wherein a duration of the slot is equal to the configured sub-slot length.

6. The UE of claim 1, wherein the UCI bits of the first and second priorities comprise HARQ-ACK information of the first priority and HARQ-ACK information of the second priority.

7. The UE of claim 1, wherein the at least one processor is configured to cause the UE to transmit the third PUCCH, wherein the third PUCCH comprises a plurality of repetitions on a plurality of transmission occasions.

8. The UE of claim 7, wherein an initial transmission occasion of the third PUCCH is determined based on a slot where an earliest symbol from the first PUCCH and the second PUCCH is located.

9. The UE of claim 7, wherein a last transmission occasion of the third PUCCH is determined based on the slot where the second PUCCH is located.

10. The UE of claim 1, wherein the at least one processor is configured to cause the UE to receive a first PUCCH configuration and a second PUCCH configuration, the first PUCCH configured using the first PUCCH configuration and the second PUCCH and the third PUCCH configured using the second PUCCH configuration.

11. The UE of claim 1, wherein the third PUCCH has a same priority as the second PUCCH and the set of PUCCH resources is determined based on a size of the UCI bits of the first and second priorities.

12. The UE of claim 1, wherein the at least one processor is configured to cause the UE to:
determine a third transmission of third UCI on a fourth PUCCH, the fourth PUCCH overlapping the first PUCCH in time, having the second priority, and being in a slot later than the slot of the second PUCCH transmission; and
transmit the UCI bits of the first and second priorities on the third PUCCH and transmitting the third UCI on the fourth PUCCH.

13. A method performed by a user equipment (“UE”), the method comprising:
determining a first transmission of first uplink control information (“UCI”) on a first physical uplink control channel (“PUCCH”), the first PUCCH having a first priority;
determining a second transmission of second UCI on a second PUCCH, the second PUCCH overlapping the first PUCCH in time and having a second priority that is higher than the first priority of the first PUCCH;
determining a set of PUCCH resources based on UCI bits of the first and second priorities from a PUCCH configuration associated with the second PUCCH, wherein the UCI bits of the first and second priorities are selected from the first and second UCI;
determining a third PUCCH based on a PUCCH resource of the set of PUCCH resources, wherein the PUCCH resource is determined based on a downlink control information (“DCI”) format among of detected one or more DCI formats indicating the second priority and a slot of the second PUCCH transmission; and
multiplexing the UCI bits of the first and second priorities on the third PUCCH for transmission in the indicated slot.

14. A network equipment for wireless communication, comprising:
at least one memory; and
at least one processor coupled with the at least one memory and configured to cause the network equipment to:
schedule a first transmission of first uplink control information (“UCI”) on a first physical uplink control channel (“PUCCH”), the first PUCCH having a first priority;
schedule a second transmission of second UCI on a second PUCCH, the second PUCCH overlapping the first PUCCH in time and having a second priority that is higher than the first priority of the first PUCCH;
select a PUCCH resource from a set of PUCCH resources for a third PUCCH, wherein the set of PUCCH resources from a PUCCH configuration associated with the second PUCCH is based on UCI bits of the first and second priorities selected from the first and second UCI; and
indicate the PUCCH resource of the set of PUCCH resources in a downlink control information (“DCI”) format of transmitted one or more DCI formats indicating the second priority and a slot of the second PUCCH transmission; and
receive the third PUCCH in the indicated slot.

15. The network equipment of claim 14, wherein the DCI format is a last DCI format among the transmitted one or more DCI formats, wherein the transmitted one or more DCI formats request hybrid automatic repeat request-acknowledgment (“HARQ-ACK”) feedback and are first indexed in an ascending order across serving cells indexes for a same PDCCH monitoring occasion and are then indexed in an ascending order across PDCCH monitoring occasion indexes.

16. A processor for wireless communication, comprising:
at least one controller coupled with at least one memory and configured to cause the processor to:
determine a first transmission of first uplink control information (“UCI”) on a first physical uplink control channel (“PUCCH”), the first PUCCH having a first priority;
determine a second transmission of second UCI on a second PUCCH, the second PUCCH overlapping the first PUCCH in time and having a second priority that is higher than the first priority of the first PUCCH;
determine a set of PUCCH resources based on UCI bits of the first and second priorities from a PUCCH configuration associated with the second PUCCH, wherein the UCI bits of the first and second priorities are selected from the first and second UCI;
determine a third PUCCH based on a PUCCH resource of the set of PUCCH resources, wherein the PUCCH resource is determined based on a downlink control information (“DCI”) format among of detected one or more DCI formats indicating the second priority and a slot of the second PUCCH transmission; and
multiplex the UCI bits of the first and second priorities on the third PUCCH for transmission in the indicated slot.

17. The processor of claim 16, wherein the DCI format is a last DCI format among the detected one or more DCI formats, wherein the detected one or more DCI formats request hybrid automatic repeat request-acknowledgment (“HARQ-ACK”) feedback and are first indexed in an ascending order across serving cells indexes for a same PDCCH monitoring occasion and are then indexed in an ascending order across PDCCH monitoring occasion indexes.

18. The processor of claim 17, wherein the PUCCH resource is determined based on a PUCCH resource indicator field in the last DCI format.

19. The processor of claim 18, wherein the at least one controller is configured to cause the processor to presume the PUCCH resource indicator field is set to ‘0’ in response to the last DCI format not comprising the PUCCH resource indicator field.

20. The processor of claim 16, wherein the PUCCH configuration associated with the second PUCCH comprises a sub-slot length, wherein a duration of the slot is equal to the configured sub-slot length.
